(19) United States
(12) Patent Application Publication
(10) Pub. No.: US 2024/0183221 A1
(43) Pub. Date: Jun. 6, 2024

(54) STABILIZER MECHANISMS FOR LADDERS, LADDERS INCORPORATING SAME, AND RELATED METHODS

(71) Applicant: LITTLE GIANT LADDER SYSTEMS, LLC, Springville, UT (US)

(72) Inventors: Steven S. Miner, Springville, UT (US); Aaron Bruce Major, Nephi, UT (US); N. Ryan Moss, Mapleton, UT (US); Leland Schuyler, Payson, UT (US)

(21) Appl. No.: 18/527,190

(22) Filed: Dec. 1, 2023

Related U.S. Application Data
(60) Provisional application No. 63/429,457, filed on Dec. 1, 2022.

(51) Int. Cl. E06C 7/48; E06C 1/08

(52) U.S. Cl. CPC E06C 7/48; E06C 1/08

(57) ABSTRACT

Stabilization mechanisms, ladders incorporating stabilization mechanisms, and related methods may include struts or braces that are automatically deployable from a collapsed configuration to a deployed or expanded configuration to support and stabilize the ladder when it is extended. The stabilizer mechanisms may include biasing members configured to urge the struts rearward and outward as a fly rail assembly of the ladder is extended relative to a base rail assembly thereof. Some stabilizer mechanisms are manually deployable independent of each other.

### CROSS-REFERENCE TO RELATED APPLICATIONS

This claims priority and the benefit of U.S. Provisional Patent Application No. 63/429,457, filed 1 Dec. 2022 and entitled “STABILIZER MECHANISMS FOR LADDERS, LADDERS INCORPORATING SAME, AND RELATED METHODS,” the entire disclosure of which is incorporated by reference.

### TECHNICAL FIELD

The present disclosure generally relates to ladders, ladder systems, ladder components, and related methods and, more specifically, to stabilizers, support arms, standoffs, and related mechanisms for ladders and related methods of manufacturing and operating the same.

### BACKGROUND

Ladders are conventionally used to provide a user thereof with improved access to locations that might otherwise be inaccessible. Ladders come in many shapes and sizes, such as straight ladders, straight extension ladders, stepladders, and combination step and extension ladders. So-called combination ladders incorporate, in a single ladder, many of the benefits of other ladder designs.

Ladders are common tools for professional tradesmen and homeowners alike. Sometimes the use of a ladder can be an awkward experience, even for those who use ladders on a regular basis, when certain tasks are to be performed while standing on the rungs of a ladder. For example, it can be easy to lose one's balance on a ladder while working on an overhead project (e.g., painting a ceiling, changing a light bulb, etc.).

Sometimes, a ladder may be unstable, or at least feel unstable, when leaning against, and supported by, an edge of a roof (e.g., the rain gutter positioned against the edge of the roof), particularly if a user reaches out beyond the side rails of the ladder while working, thereby changing the load dynamics experienced by the ladder. Thus, when leaning a ladder against a support surface (a wall, the edge of a roof, etc.), sometimes it is desirable to provide additional stability.

While various accessories or “add-on” features may help to provide an improved stability and safety, if a ladder becomes laden with too many accessories, it becomes overly heavy, awkward to maneuver, and difficult to store and transport. Additionally, stabilizers that are difficult to deploy or store may be ignored. Thus, in some instances, users would prefer to do without accessories or features that might otherwise provide increased stability or safety during use of a ladder.

It is a continual desire within the industry to improve various aspects of ladders.

### SUMMARY

One aspect of the present disclosure relates to a ladder, comprising: a first assembly including a first pair of rails and a first plurality of rungs extending between and coupled to the first pair of rails; a second assembly including a second pair of rails and a second plurality of rungs extending between and coupled to the second pair of rails, with the second pair of rails being displaceable relative to the first pair of rails between a collapsed configuration and an extended configuration; and a stabilizer mechanism mounted to at least one rail of the first pair of rails and including: a strut having a top end and a bottom end, with the top end being pivotally coupled with the at least one rail on a laterally outer side of the at least one rail; and a biasing member, wherein in response to displacement of the first pair of rails from the collapsed configuration to the extended configuration, the biasing member applies a force to the stabilizer mechanism pivoting the strut at the top end to extend the bottom end outward relative to the at least one rail.

In some embodiments, the stabilizer mechanism further comprises: a link member pivotally coupled to the strut; and a pivot bracket slidably coupled with the at least one rail of the first pair of rails and pivotally coupled to the link member.

In some embodiments, the biasing member is configured to apply the force to the bracket to pivot the strut via the link member.

In some embodiments, the stabilizer mechanism further comprises: a second strut pivotally coupled with a second rail of the first pair of rails; a second link member pivotally coupled to the second strut; and a second bracket slidably coupled with the second rail and pivotally coupled to the second link member.

In some embodiments, the stabilizer mechanism further comprises a cross-link member coupling the pivot bracket and the second bracket.

In some embodiments, when the strut is in the collapsed configuration, the strut is substantially parallel to the at least one rail.

In some embodiments, a pivot axis of the strut is oriented at a non-orthogonal angle relative to a plane in which the first pair of rails lies.

In some embodiments, the strut is configured to rotate laterally outward relative to the at least one rail.

In some embodiments, the biasing member is directly coupled with the at least one rail.

In some embodiments, the ladder further comprises a ramp formed on the at least one rail, wherein the strut is configured to pivot into contact with the ramp. In some embodiments, the ramp comprises a surface configured to resist movement of the strut away from the collapsed configuration.

Another aspect of the disclosure relates to a ladder, comprising: a first assembly including a first pair of rails and a first plurality of rungs extending between and coupled to the first pair of rails; a second assembly including a second pair of rails and a second plurality of rungs extending between and coupled to the second pair of rails, with the second pair of rails being displaceable relative to the first pair of rails between a collapsed configuration and an extended configuration; and a stabilizer mechanism mounted to at least one rail of the first pair of rails and including: a strut having a first end and a second end, the first end being pivotally coupled with at least one rail of the first pair of rails; a link member pivotally coupled with the strut; a bracket slidably coupled with the at least one rail; and a handle assembly slidably coupled with the at least one rail and coupled with the bracket, wherein sliding movement of the handle assembly is configured to pivot the strut via the bracket and via the link member.

In some embodiments, the handle assembly comprises a grip body and a latch member coupled with the grip body, with the latch member being movable between a first position locking the grip body relative to the rail and a second position permitting movement of the grip body relative to the rail. In some embodiments, the latch member is lockable relative to the rail in a plurality of spaced apart positions on the rail.

In some embodiments, the stabilizer mechanism further comprises a rod linking the handle assembly to the bracket. In some embodiments, the stabilizer mechanism further comprises a support bracket coupled to the rail and to the rod.

Additionally, in some embodiments, the strut is a first strut and the ladder further comprises a second stabilizer mechanism including: a second strut pivotally coupled with a second rail of the first pair of rails; a second link member pivotally coupled with the second strut; and a second bracket slidably coupled with the second rail; wherein the second strut is deployable to a first angular displacement from the second rail while the first strut is deployed to a second angular displacement from the at least one rail.

Yet another aspect of the disclosure relates to a stabilizer mechanism for a ladder, the stabilizer mechanism comprising: a strut having an end pivotally attachable to a rail; a bracket slidably attachable to the rail; a link member having a first end pivotally attached to the strut and a second end pivotally attached to the bracket, wherein movement of the bracket relative to the end of the strut is configured to rotate the strut via the link member; and a handle assembly slidably attachable to the rail and coupled with the bracket.

In some embodiments, the bracket forms a channel configured to receive a web or flange portion of the rail. In some embodiments, the handle assembly comprises a latch member configured to lock the handle assembly relative to the rail.

The above summary is not intended to describe each embodiment or every implementation of the embodiments disclosed herein. The figures and the detailed description that follow more particularly exemplify one or more preferred embodiments.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is an isometric view of a ladder in a collapsed configuration and a detail view of the same.

FIG. 2 is an isometric view of the ladder of FIG. 1 in an extended configuration and a detail view of the same.

FIG. 3 is a front view of the ladder of FIG. 1.

FIG. 4 is a front view of the ladder of FIG. 3 in a partially extended position.

FIG. 5 is a front view of the ladder of FIG. 3 in a fully extended position.

FIG. 6 is a side view of the ladder of FIG. 3.

FIG. 7 is a side view of the ladder of FIG. 5.

FIG. 8 is an isometric view of rails of the ladder of FIG. 1.

FIG. 9 is an isometric view of the ladder of FIG. 4.

FIG. 10 is an isometric view a ladder in a collapsed configuration.

FIG. 11 is a side view of the ladder of FIG. 10 with a detail view of the same.

FIG. 12 is an isometric view of the ladder of FIG. 10 in an expanded configuration.

FIG. 13 is a side view of the ladder of FIG. 12 with a detail view of the same.

FIG. 14 is an isometric view of a collapsed stabilizer mechanism on a ladder.

FIG. 15 is a front view of the ladder of FIG. 14.

FIG. 16 is a side view of the ladder of FIG. 14 with a link member shown transparently.

FIG. 17 is an isometric view of a ladder with the stabilizer mechanism in a transitional state.

FIG. 18 is a side view of a ladder with the stabilizer mechanism in a transitional state.

FIG. 19 is a front view of a ladder with the stabilizer mechanism in a transitional state.

FIG. 20 is a top view of a ladder with the stabilizer mechanism in a transitional state.

FIG. 21 is a top view of a ladder with the stabilizer mechanism in a collapsed state.

FIG. 22 is an isometric view of a ladder with the stabilizer mechanism in a collapsed state.

FIG. 23 is an isometric view of a ladder with the stabilizer mechanism in an expanded state.

FIG. 24 is an isometric view of a ladder with a stabilizer mechanism in a collapsed state.

FIG. 25 is an isometric view of the ladder of FIG. 24 with the stabilizer mechanism in a transitional state.

FIG. 26 is an isometric view of the ladder of FIG. 25 with the stabilizer mechanism in an extended state.

FIG. 27 is an isometric view of a ladder having stabilizer mechanisms in a first deployed state.

FIG. 28A is an isometric view of the stabilizer mechanisms of the ladder of FIG. 27 isolated from the rest of the ladder.

FIG. 28B is an isometric view showing components of a stabilizer mechanism of the ladder of FIG. 27 in greater detail.

FIG. 29A is a cross-sectional view of the handle assembly of a stabilizer mechanism (as taken through section lines 29-29 in FIG. 28B) in a locked state and mounted to a rail.

FIG. 29B is a cross-sectional view of the handle assembly of FIG. 29A in an unlocked state.

FIG. 30 is a right side view of the ladder of FIG. 27 with the stabilizer mechanisms in the first deployed state and shown relative to a ground support surface and a vertical support surface.

FIG. 31 is a right side view of the ladder of FIG. 27 with the stabilizer mechanisms in a second deployed state and shown relative to a ground support surface and an elevated, sloped support surface.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The present description provides examples, and is not limiting of the scope, applicability, or configuration set forth in the claims. Thus, it will be understood that changes may be made in the function and arrangement of elements discussed without departing from the spirit and scope of the disclosure, and various embodiments may omit, substitute, or add other procedures or components as appropriate. For instance, the methods described may be performed in an order different from that described, and various steps may be added, omitted, or combined. Also, features described with respect to certain embodiments may be combined in other embodiments.

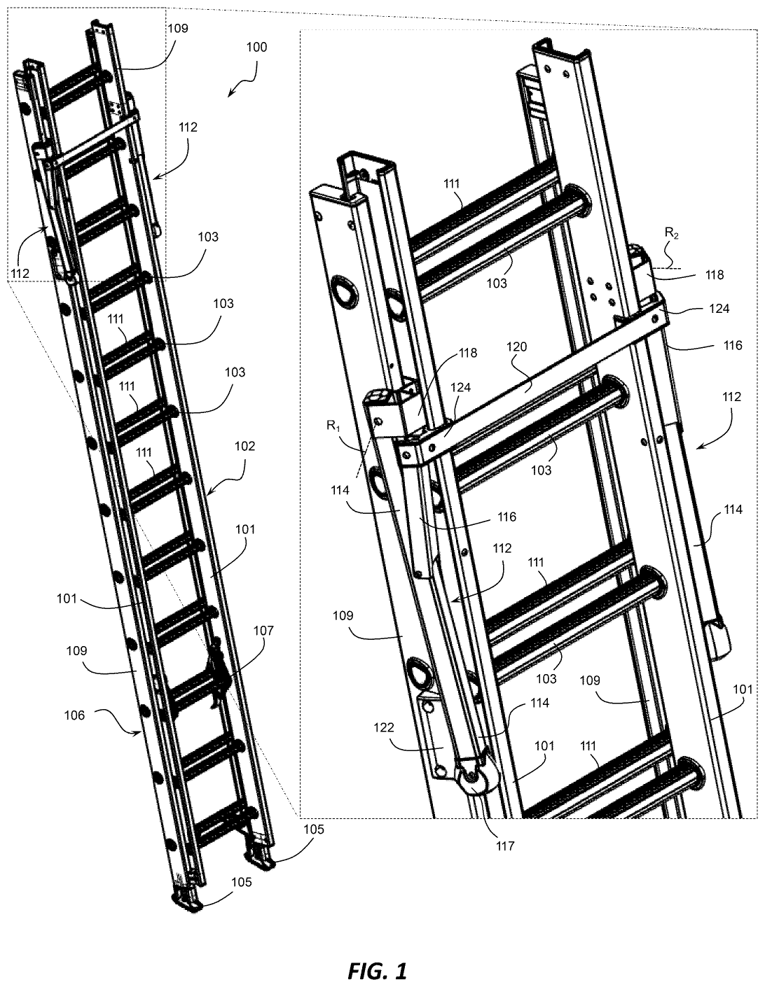

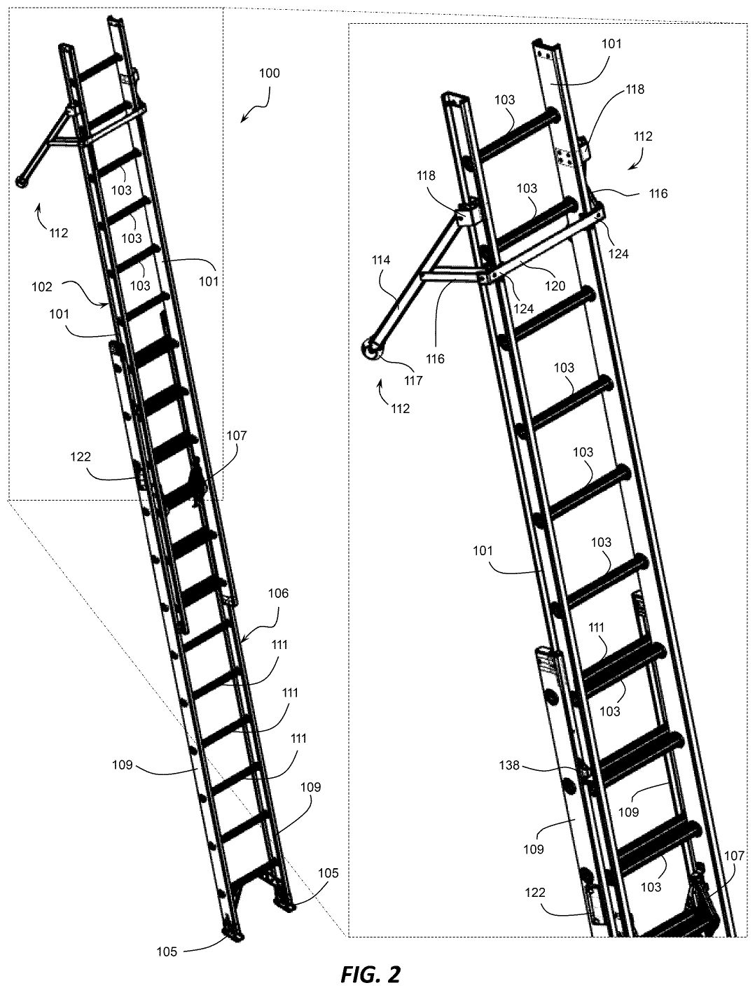

FIGS. 1-2 show isometric views of a ladder 100 (including detail views) according to an embodiment of the present disclosure. The ladder 100 may comprise a first assembly 102 (i.e., a fly assembly) including a first pair of rails 101 (e.g., front, inner, or fly rails) and a first plurality of rungs 103 (i.e., steps or lateral supports) extending between, and coupled to, the first pair of rails 101. The ladder 100 may further include a second assembly 106 (i.e., a base assembly) including a second pair of rails 109 (e.g., base, rear, or outer rails) and a second plurality of rungs 111 (e.g., rear horizontal struts or lateral supports). The rungs 103, 111 may stiffen the first assembly 102 and second assembly 106, respectively, and may provide structural rigidity to the ladder 100. A pair of adjustable feet 105 may be coupled to and positioned at bottom ends of the second pair of rails 109.

The second assembly 106 may be referred to as a base assembly or base section of the ladder 100, and the first assembly 102 may be referred to as a fly assembly or fly section of the ladder 100. The ladder 100 may be an extension ladder, wherein the overall major/longitudinal length of the ladder 100 may be elongated or contracted based primarily on longitudinal displacement adjustment of the fly assembly 102 relative to the base assembly 106. A longitudinal adjustment mechanism 107 may be employed to control the locked or unlocked coupling of the assemblies 102, 106 in various relative ladder length positions. For example, a longitudinal adjustment mechanism 107 may be a ratcheting mechanism configured to hold the ladder in its most extended configuration unless unlocked and permitted to retract to a collapsed configuration. FIG. 1 shows the ladder 100 in a fully contracted, retracted, or collapsed configuration, and FIG. 2 shows the ladder 100 in an extended and lengthened configuration.

An upper end of the first assembly 102 may include a pair of stabilizer mechanisms 112, each of which may be positioned on a respective laterally outer side of the rails 101. The stabilizer mechanisms 112 may each comprise a strut 114 pivotally coupled with the rail 101 at a first bracket 118 (i.e., an upper bracket or stationary pivot bracket). The stabilizer mechanisms 112 may also each comprise a link member 116 pivotally coupled to the strut 114 and to a second bracket 124 (i.e., a lower bracket or sliding pivot bracket) at an end of a cross-link member 120. A retention ramp 122 may be positioned on a laterally outer side surface of each of the second pair of rails 109. In some embodiments, the first bracket 118 and the rail 101 and/or the second bracket 124 and the rail 101 may be integrally formed as a single part. Thus, the strut 114 and link member 116 may each be pivotally directly coupled with the rail 101.

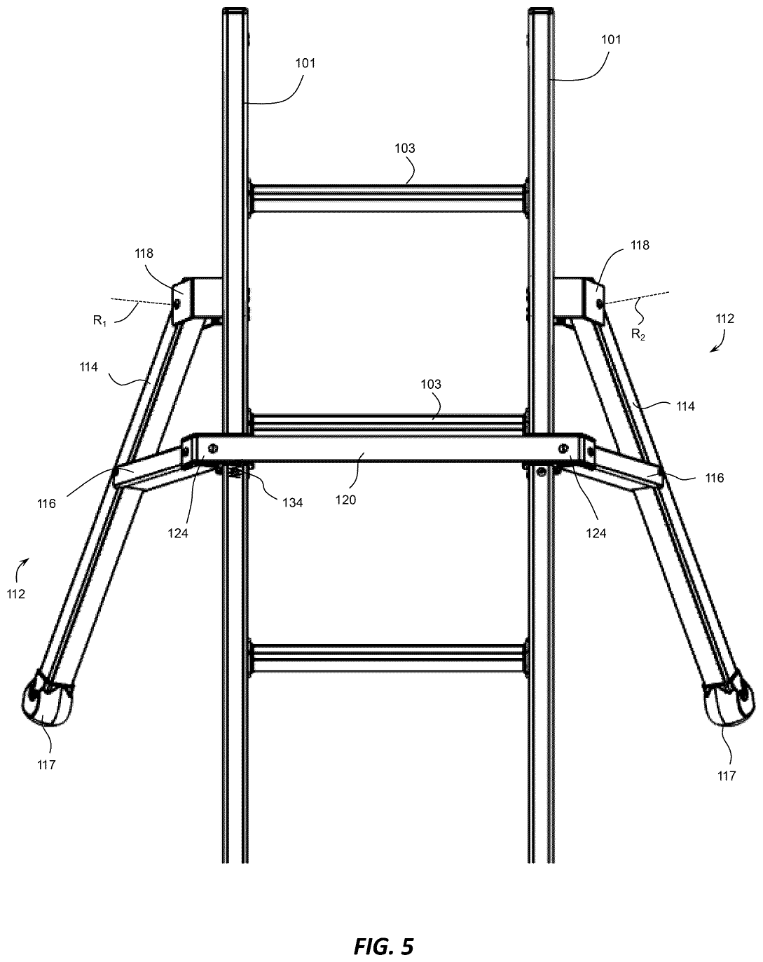

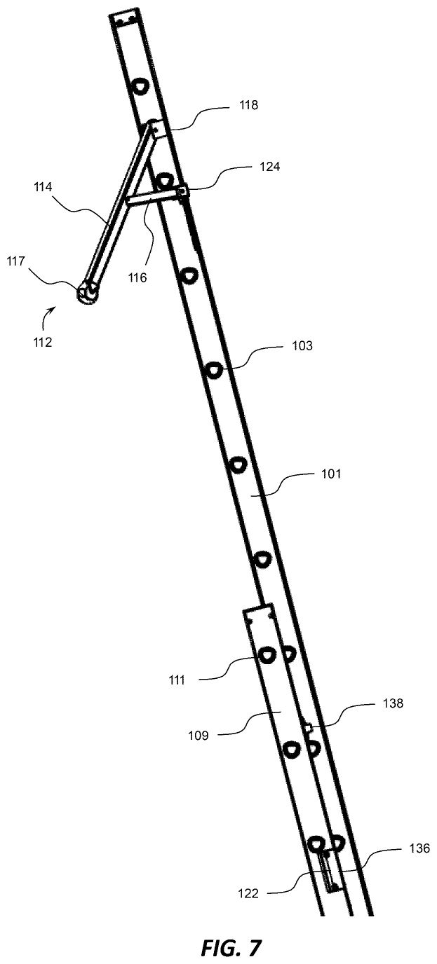

The stabilizer mechanisms 112 may be configurable in a collapsed or folded configuration, as shown in FIG. 1, and may be configurable in an expanded or unfolded configuration, as shown in FIG. 2. When in the collapsed configuration, the stabilizer mechanisms 112 may be compactly positioned against the rails 109 for convenient storage, transportation, and shipping of the ladder 100 from place to place. When in the expanded configuration, the stabilizer mechanisms 112 may extend at least partially rearward of the fly rails 101 (see FIG. 7) and, in some embodiments, may extend laterally outward from the fly rails 101 as well (see FIG. 5). The positioning of the stabilizer mechanisms 112 in the expanded configuration can help support and stabilize the ladder 100 against walls and atop flat or sloped top surfaces such as roofs. In one example implementation, the stabilizer mechanisms 112 can contact a roof so that the ladder 100 does not contact rain gutters at an edge of the roof.

As explained herein, the stabilizer mechanisms 112 may be configured to automatically deploy or expand from their collapsed configuration to their expanded configuration in response to extension of the ladder 100 from a collapsed configuration (e.g., FIGS. 1, 3, and 6) to an extended configuration (e.g., FIGS. 2, 5, and 7). Components of the stabilizer mechanisms 112 may include biasing mechanisms to actuate the struts 114 and to make them move outward relative to the fly rails 101 when the fly rails 101 reach a predetermined position relative to the base rails 109 as the fly rails 101 transition from the collapsed configuration to the extended configuration. Stabilizer mechanisms 112 may also be configured to automatically stow or collapse in response to retraction or collapsing of the ladder 100 from its extended configuration to its collapsed configuration.

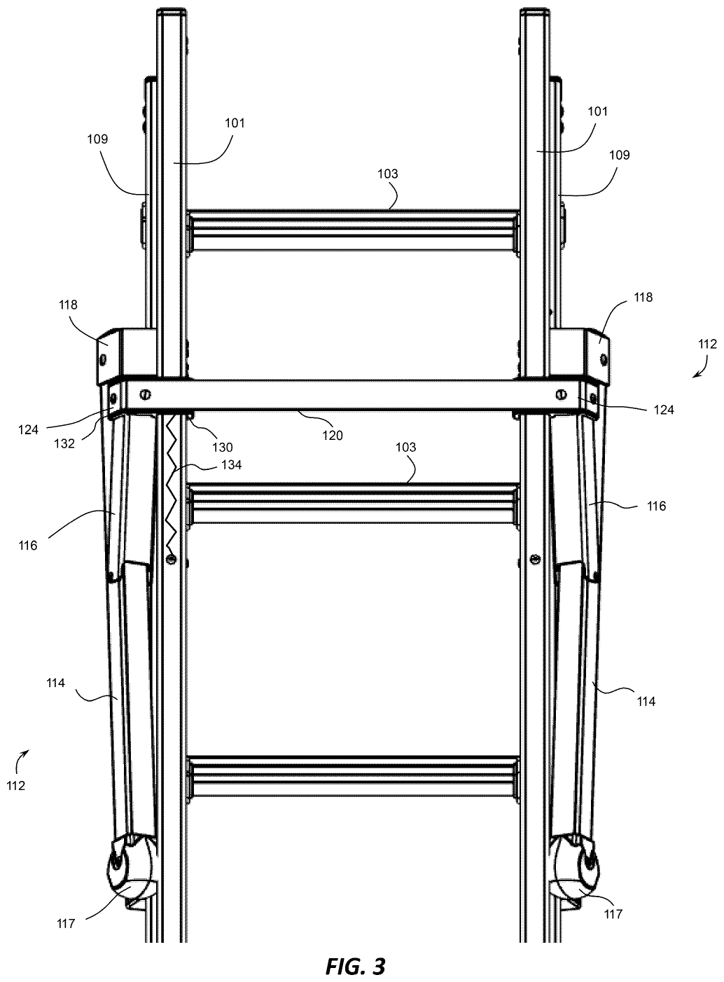

The strut 114 may be a substantially linear and rigid member of the stabilizer mechanism 112 configured to provide support for the ladder 100 when deployed. The strut 114 may include a foot 117 (i.e., an engagement end or contactor) configured to come into contact with a support surface toward which the ladder 100 leans. The foot 117 may comprise a frictional enhancement material (e.g., rubber, elastic polymer, or other resilient material) or texture (e.g., knurled, ridged, grooved, or spiked) configured to increase friction against the support surface and thereby reduce sliding of the strut 114 against the support surface. The strut 114 may be pivotally connected to the first bracket 118 and, via its pivotal connection to bracket 118, may rotate in a plane that is oriented at a non-orthogonal angle relative to the plane in which the fly rails 101 are positioned, as indicated in FIGS. 3-7.

The link member 116 may be pivotally connected to the strut 114 and to the second bracket 124. The link member 116 may be substantially linear and rigid. In its collapsed configuration, the link member 116 may extend in a somewhat parallel orientation relative to the strut 114, and when the link member 116 is in its extended configuration, it may extend at a significantly larger angle relative to the strut 114 and may, with the strut 114 and rail 101, form a triangular shaped brace configuration in the stabilizer mechanism 112. In some embodiments, the link member 116 may be substantially horizontally oriented when fully deployed, as shown in FIG. 5.

Each first bracket 118 may be affixed to each fly rail 101. The first bracket 118 may directly pivotally couple with the upper end of the strut 114. A pivot axis R₁, R₂ (see FIGS. 1 and 5) of each respective strut 114 may be defined through their respective first bracket 118, and each pivot axis may be oriented at a non-orthogonal angle relative to a plane in which the fly rails 101 lie and to which the front-facing surface of the cross-link member 120 is parallel.

The cross-link member 120 may be slidably coupled with both of the fly rails 101 at the second brackets 124. As shown in FIG. 1, the cross-link member 120 may include an inner-positioned rail-engaging bracket portion 130 and an outer-positioned link-engaging bracket portion 132. The rail-engaging bracket portion 130 may at least partially wrap around a portion of a rail 101 (e.g., a side flange of a channel of the rail 101) and may therefore remain in sliding contact with the rail 101 as it moves longitudinally along the rail between collapsed and expanded configurations. See FIGS. 3-5. A biasing member (e.g., a spring or weight) may be attached to the cross-link member 120, such as by being positioned internal to a channel of at least one fly rail 101. An example biasing member 134 is schematically shown as an extension spring in FIGS. 3-5. The biasing member may bias the second brackets 124 longitudinally away from (e.g., downward from) the first brackets 118. Longitudinal movement of the cross-link member 120 may urge the link members 116 to pivot at the second brackets 124 and to thereby urge the struts 114 toward their expanded and extended positions. In some embodiments, a biasing member may be positioned on each side of the cross-link member 120. Biasing members may be implemented as compression springs and may be positioned laterally external to the fly rails 101, as will be understood by those having ordinary skill in the art and having the benefit of the present disclosure.

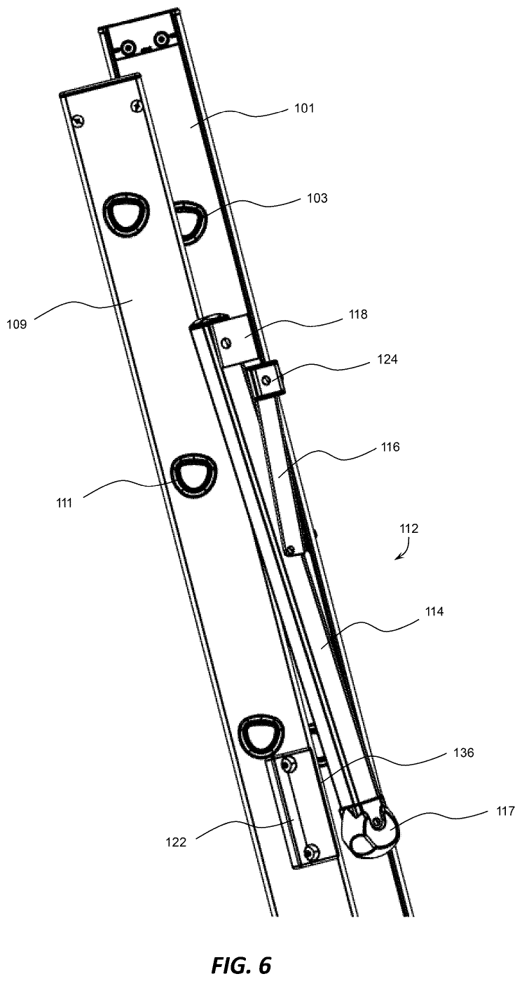

The action of the biasing member(s) may enable automatic deployment of the stabilizer mechanisms 112. In order to prevent automatic deployment while the ladder 100 is in a collapsed configuration, the retention ramp 122 on each laterally outer side of the base rails 109 may comprise a blocking surface 136. See FIGS. 6-8. The blocking surface 136 may engage the strut 114 or foot 117 while the stabilizer mechanism 112 is in the collapsed configuration, and the engagement between the strut/foot and the blocking surface 136 may mechanically interfere with rearward/outward movement of the strut 114 toward the expanded configuration. Thus, the blocking surface 136 may resist release of potential energy from the biasing member 134 that would open the stabilizer mechanisms 112.

When the user wishes to extend the ladder 100, the first assembly 102 may move longitudinally upward and parallel to the second assembly 106, thereby moving the strut 114 and foot 117 upward and parallel to the second assembly 106. After clearing the blocking surface 136, the strut 114/foot 117 may, in response to the biasing force of the biasing member 134, automatically transition outward and rearward to the expanded configuration.

In some embodiments, the retention ramp 122 may not necessarily be used to prevent rotation of the strut 114 or foot 117 with a blocking surface 136. For instance, the base rails 109 may each comprise a folding tab 138 extending away from a side surface (e.g., front surface 140) of the rails 109. See FIGS. 2, 8, and 9. When the ladder 100 is collapsed, the stabilizer mechanism 112 may have the second bracket 124 in contact with the folding tab 138 since the folding tab 138 extends away from the front surface 140 to a sufficient distance to contact the second bracket 124. Accordingly, even though the biasing member 134 applies a force drawing the second bracket 124 toward the bottom of the ladder 100, the contact between the second bracket 124 and the folding tab 138 may prevent downward movement of the second bracket 124.

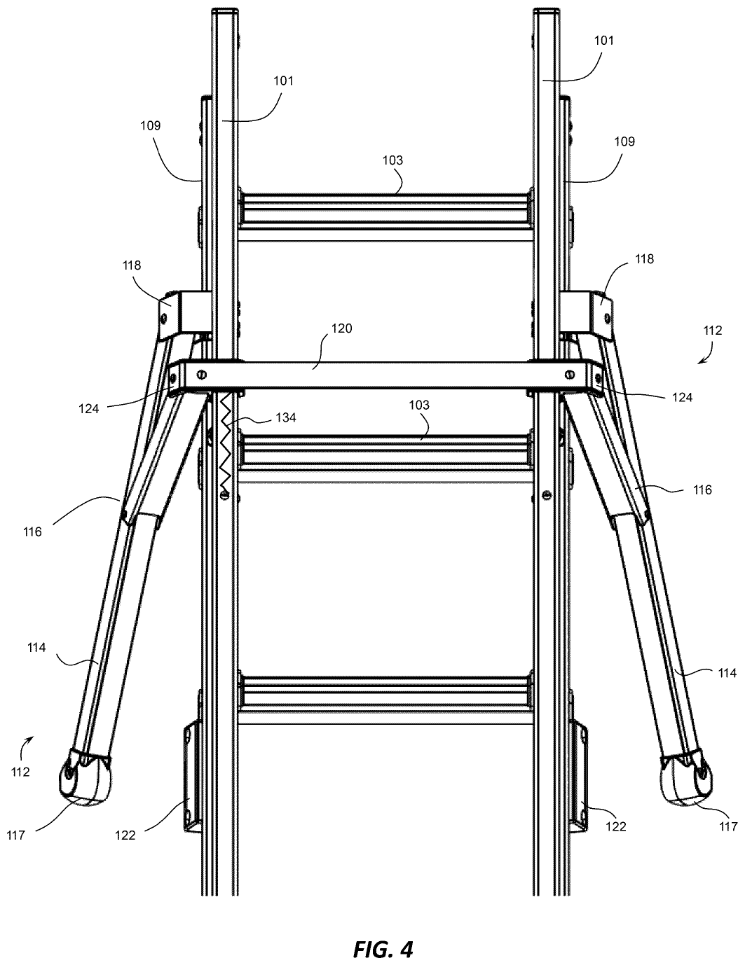

When the ladder 100 is expanded and extended by the user, the fly rails 101 move the stabilizer mechanisms 112 upward. The first brackets 118 begin to move upward and away from the second brackets 124, as illustrated in the difference between FIGS. 3 and 4, so the struts 114 start to rotate toward their extended positions. Eventually, the second brackets 124 are biased downward by the biasing member to their lowest possible positions, e.g., as shown in FIG. 5, and the fly rails 101 continue to move upward, thereby creating space between the second brackets 124 and the folding tabs 138. Thus, relative movement of the folding tabs 138 away from the first brackets 118 and then away from the second brackets 124 allows complete expansion of the stabilizer mechanisms 112.

When the time comes to collapse the stabilizer mechanisms 112 again, the second brackets 124 may move downward as the fly rails 101 are drawn down until the second brackets 124 contact the folding tabs 138 again. Continued downward movement after first contact may move the first brackets 118 toward the second brackets 124, thereby inducing collapse and folding rotation of the struts 114. Eventually, the folding tabs 138 have pressed the second brackets 124 close enough to the first brackets 118 to return to the fully collapsed position of FIG. 3. Potential energy may be once again stored in the biasing member, and that energy may be used to expand the stabilizer mechanisms 112 once again.

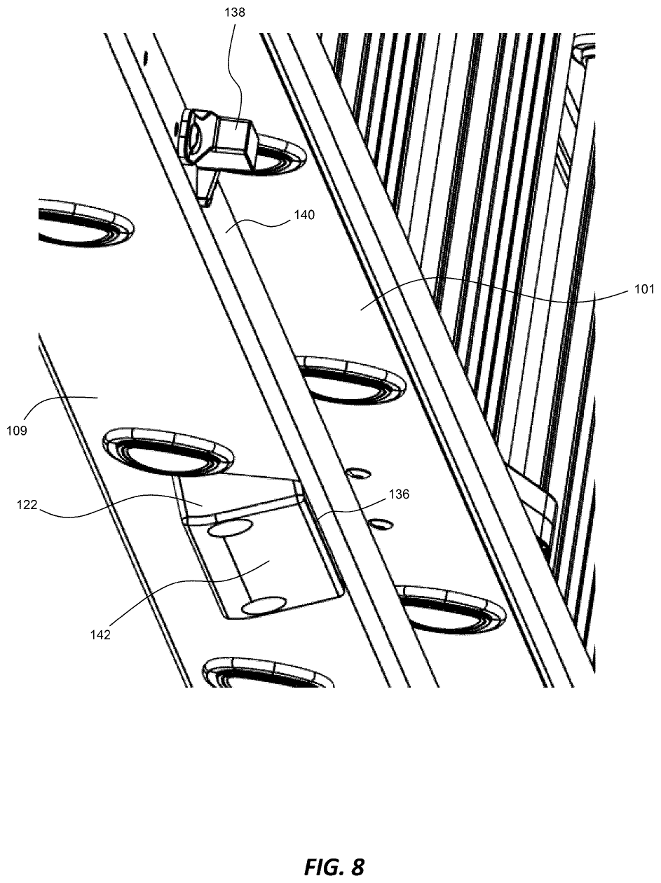

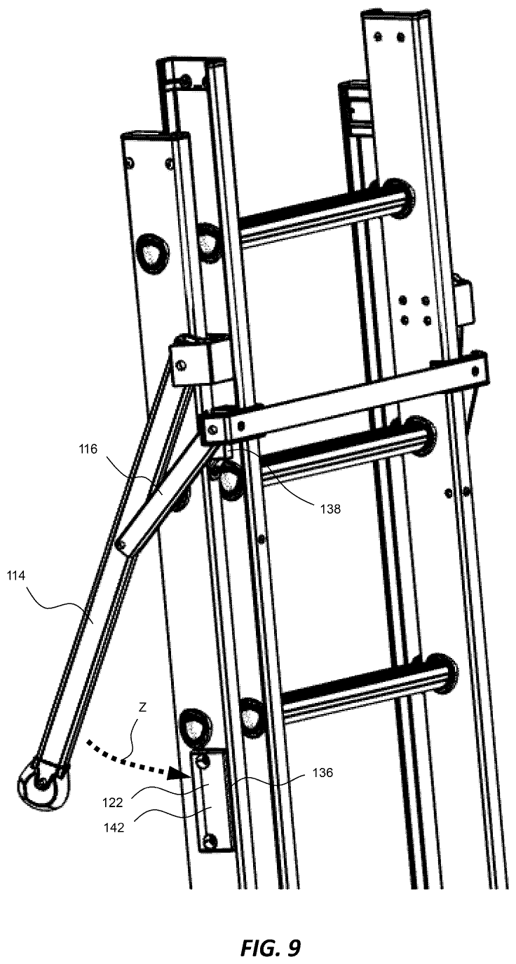

In some embodiments, the retention ramp 122 on each side of the ladder 100 may help guide the foot 117 or strut 114 toward the front surfaces 140 of the base rails 109. As the strut 114/foot 117 moves toward the storage/collapsed position, the retention ramp 122 may have a laterally outer surface against which the strut 114/foot 117 slides to reach the front of the base rails 109. This may help prevent the strut 114 from getting stuck while positioned on a lateral side of the base rail 109 and may help the strut 114/foot 117 apply a force that helps to drive the second bracket 124 upward relative to the retention ramp 122 (via the link member 116). The slope of the retention ramp 122 is shown in FIG. 8 to slope toward the front surface 140 of the base rail 109. The non-orthogonal plane in which the strut 114 rotates may intersect the ramped face 142 of the retention ramp 122 so that the strut 114/foot 117 is ensured to engage the ramped face 142 when collapsing, as indicated by arrow Z in FIG. 9. The blocking surface 136 may then help retain the strut 114/foot 117 in the collapsed position, even when the ladder 100 shakes or the strut 114 is bumped or jostled while in the collapsed configuration. Contact with the blocking surface 136 under these conditions may minimize torque on the hinges and pivots of the stabilizer mechanism 112 and may therefore help improve durability and longevity of the stabilizer mechanism 112.

In various embodiments, the ladder 100 may comprise one or two stabilizer mechanisms 112, such as one on each side of the ladder 100 or one on only one side thereof. The stabilizer mechanisms 112 may be independently deployable and stowable, such as, for example, if the cross-link member 120 is disconnected in its center and only the second brackets 124 remain. Thus, components of one stabilizer mechanism 112 may remain stationary while other components are repositioned. Elements and features of the ladder 100 have been described in connection with FIGS. 1-9 that may be used in combination with, or in place of, features described in connection with other embodiments referenced herein. Accordingly, the embodiment shown in FIGS. 1-9 should be understood as an example embodiment having various features that may be used in isolation or as an assembly/combined sets of components and mechanisms.

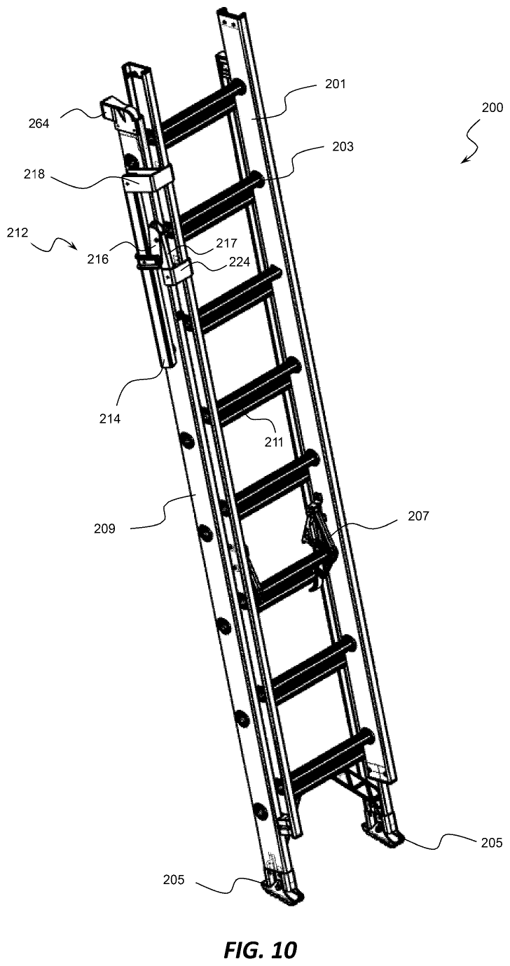

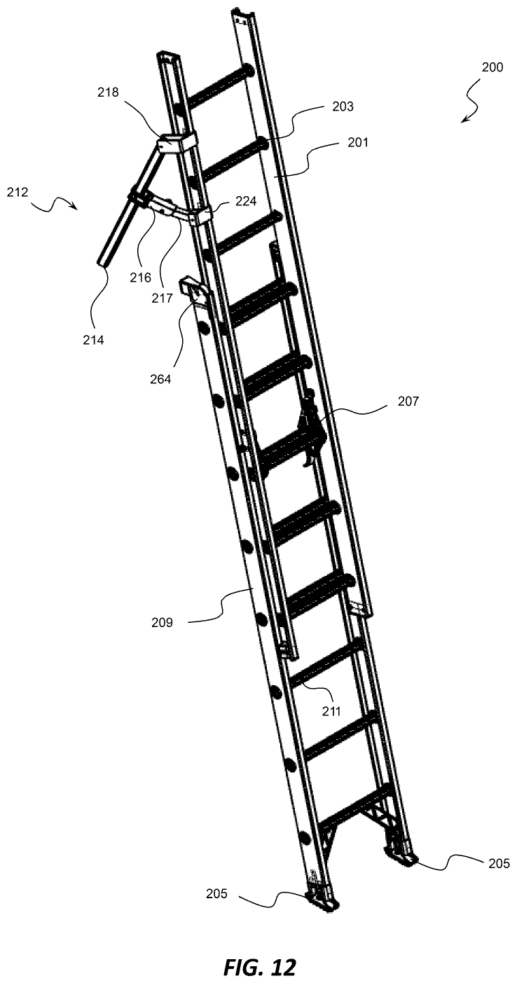

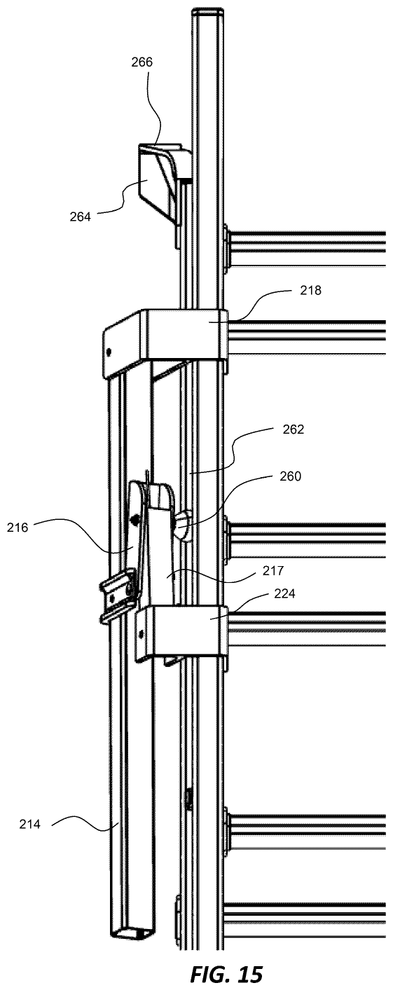

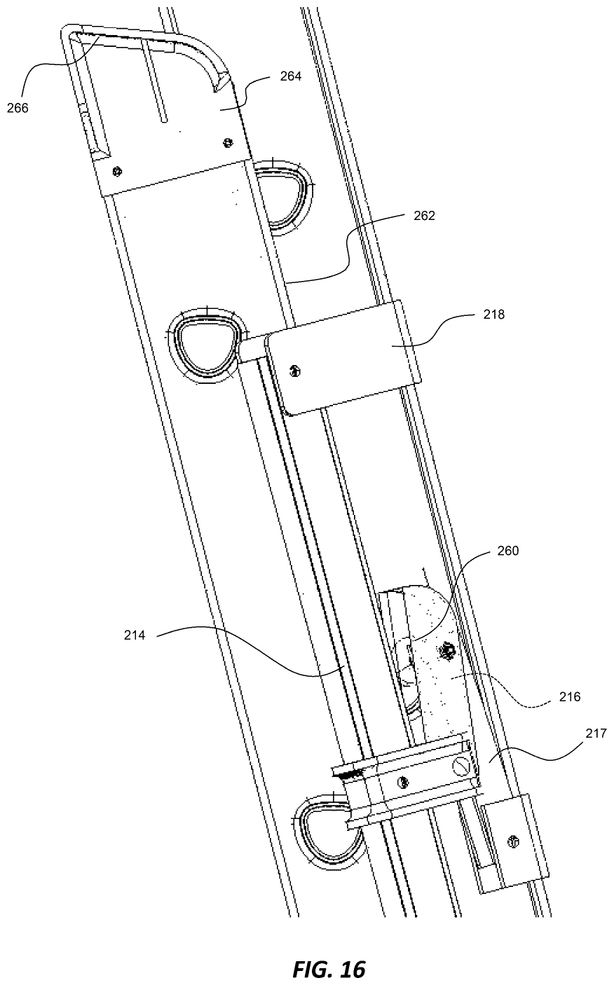

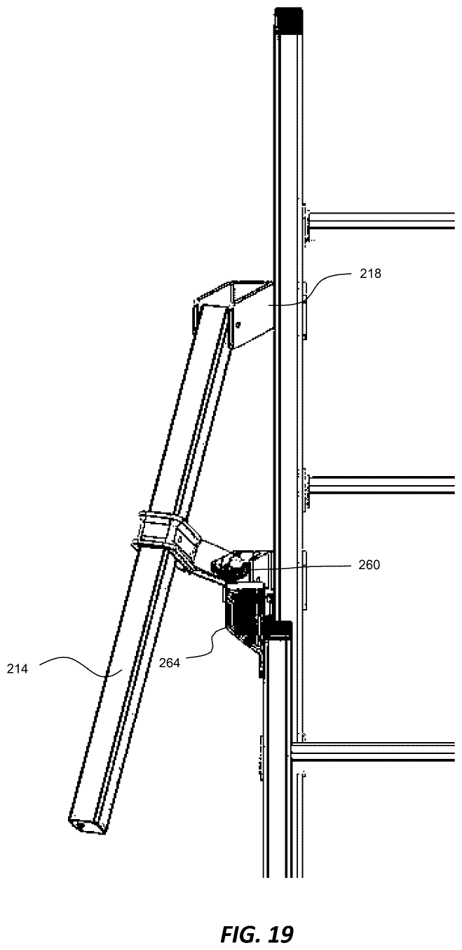

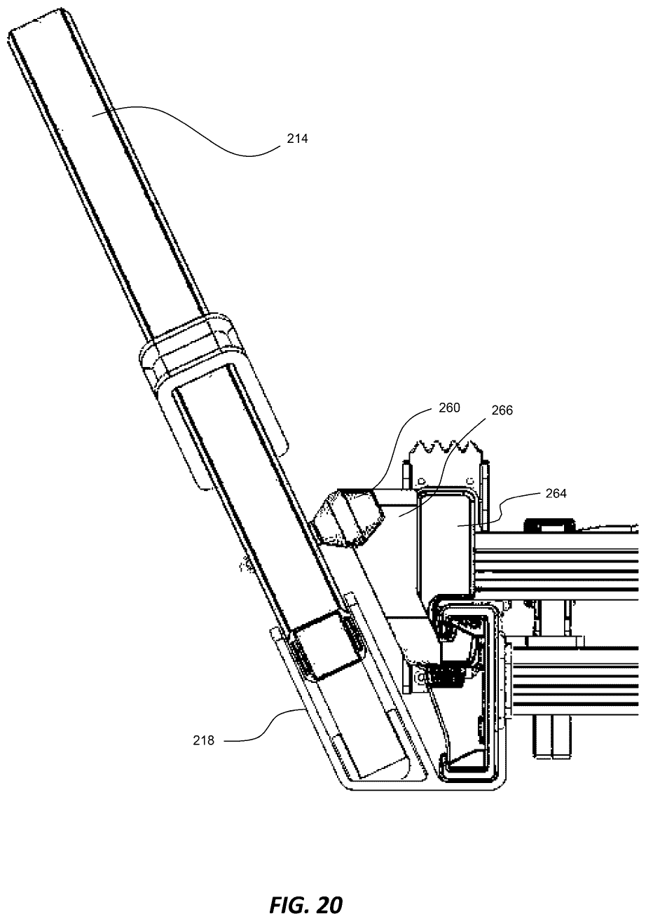

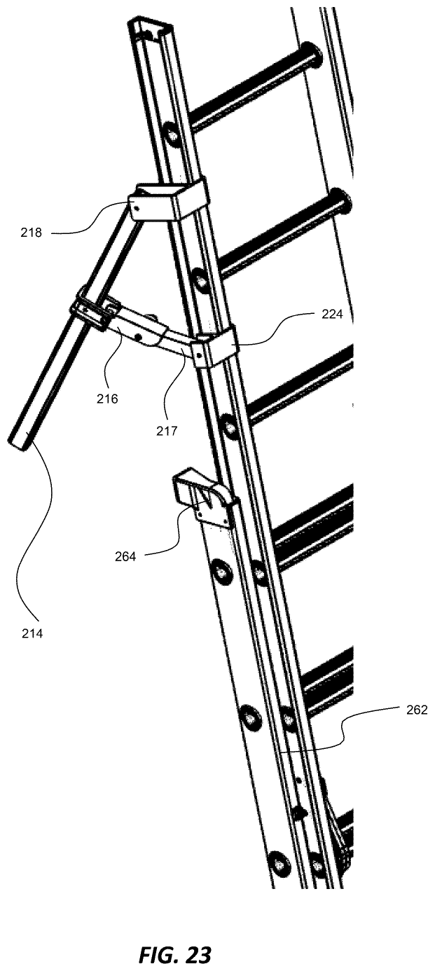

FIGS. 10-23 illustrate additional components and features of a ladder 200 that may include stabilizer mechanisms 212 that provide functions and capabilities similar to stabilizer mechanisms 112. The ladder 200 may include fly rails 201, base rails 209, front rungs 203, rear rungs 211, adjustment mechanism 207, and feet 205 that may function similar or identical to similarly numbered components in ladder 100. FIGS. 10-11, 14-16, 21, and 22 show the ladder 200 in a collapsed configuration, and FIGS. 12-13 and 23 show the ladder 200 in a fully extended configuration. One stabilizer mechanism 212 may be positioned on the laterally outer side of each fly rail 201 and may automatically transition from the collapsed to the extended configuration in response to movement of the fly rails 201 relative to the base rails 209.

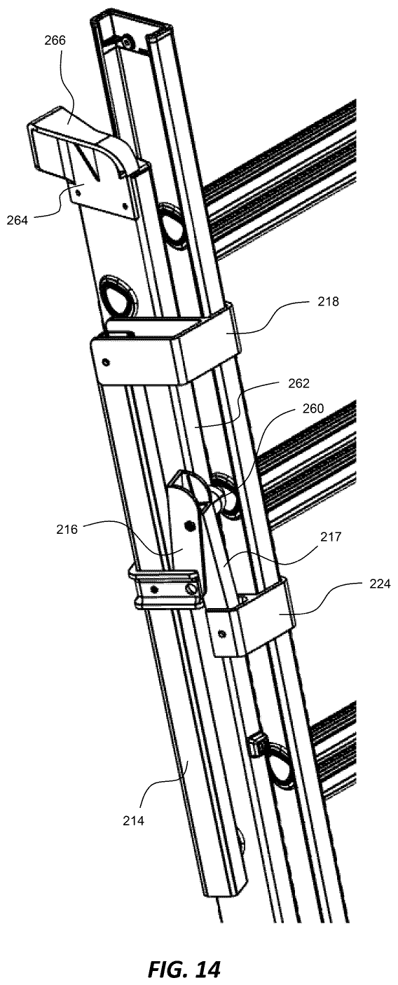

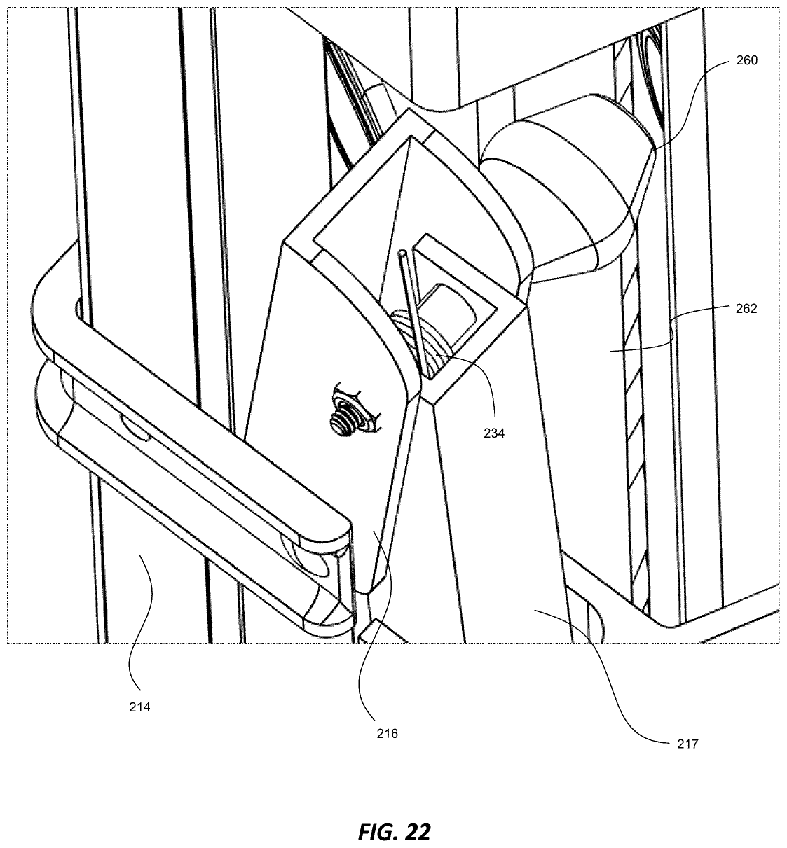

The stabilizer mechanisms 212 may each include a strut 214, an upper bracket 218, a lower bracket 224, and a pair of link members 216, 217. In some embodiments, an engagement member (e.g., a foot, end cap, etc.) may be positioned on or incorporated into the end of the strut 214, similar to foot 117. The upper and lower brackets 218, 224 may be directly coupled to the fly rail 201 at fixed positions. The first link member 216 may be pivotally coupled with the strut 214 and with the second link member 217. The second link member 217 may be pivotally coupled with the rail 201. Accordingly, when in the folded/collapsed configuration, the strut 214 and link members 216, 217 may pivot into the position shown in FIG. 14 with the strut 114 substantially parallel to the fly rail 201 and positioned laterally external to the base rail 209. The stabilizer mechanism 212 may be acted upon by a biasing member (e.g., torsion spring 234 in FIG. 22) that, directly or indirectly, drives apart the joint coupling the first and second link members 216, 217 to each other. Accordingly, the stabilizer mechanism 212 may be biased toward an open/unfolded position. In some embodiments, the biasing member may be positioned external to the link members 216, 217, similar to biasing member 134. The biasing member may be a weight or other type of spring configured to apply a biasing force to the stabilizer mechanism 212 that urges it to its expanded configuration.

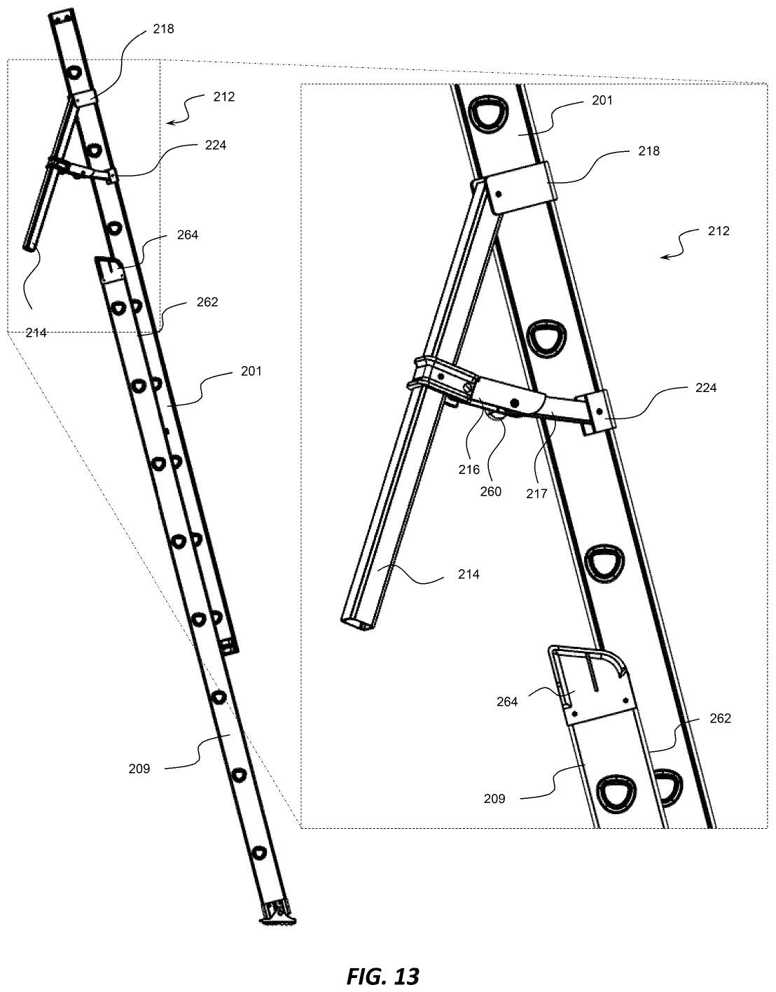

A follower 260 (e.g., a wheel, knob, tab, or protrusion) may extend from the stabilizer mechanism 212 toward contact with the front-facing surface 262 of a base rail 209. See FIGS. 13-22. The follower 260 may extend from the first or second link member 216, 217 in a substantially laterally inward direction and may comprise a rounded (e.g., cylindrical or conical) contact surface configured to engage the surface 262 of the base rail 209. The contact between the follower 260 and the base rail 209 may mechanically interfere with unfolding of the stabilizer mechanism 212, so the stabilizer mechanism 212 may remain folded while the follower 260 is positioned somewhere between the ends of the base rail 209.

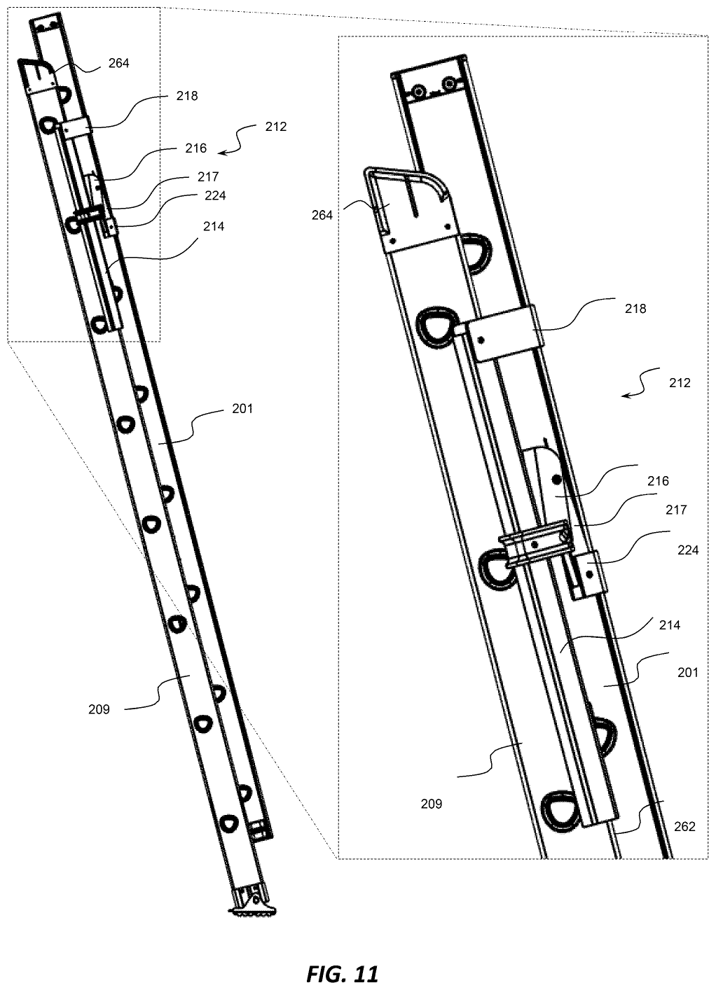

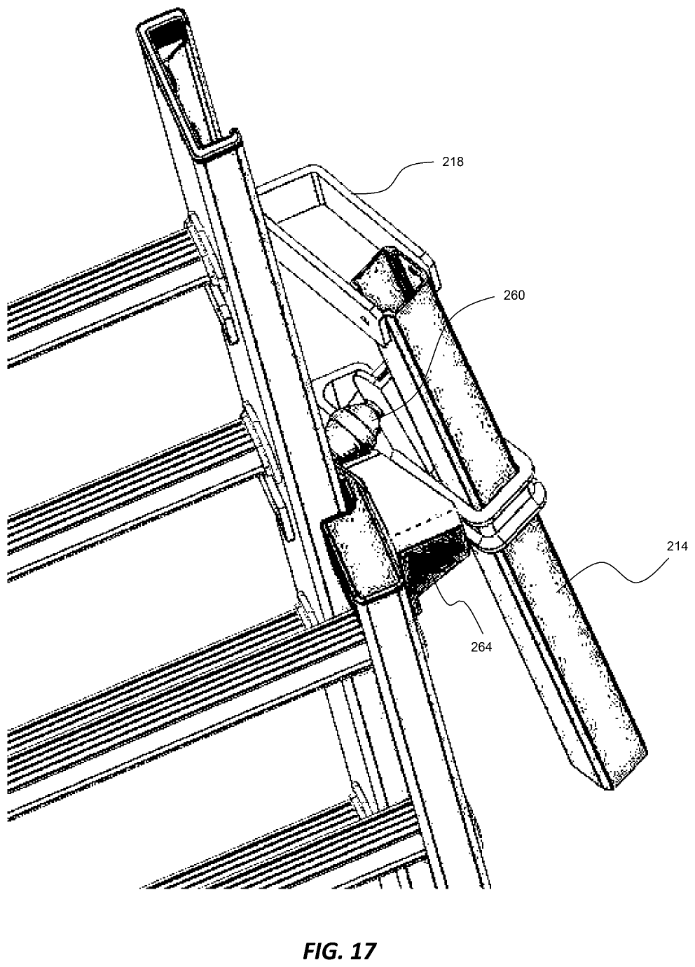

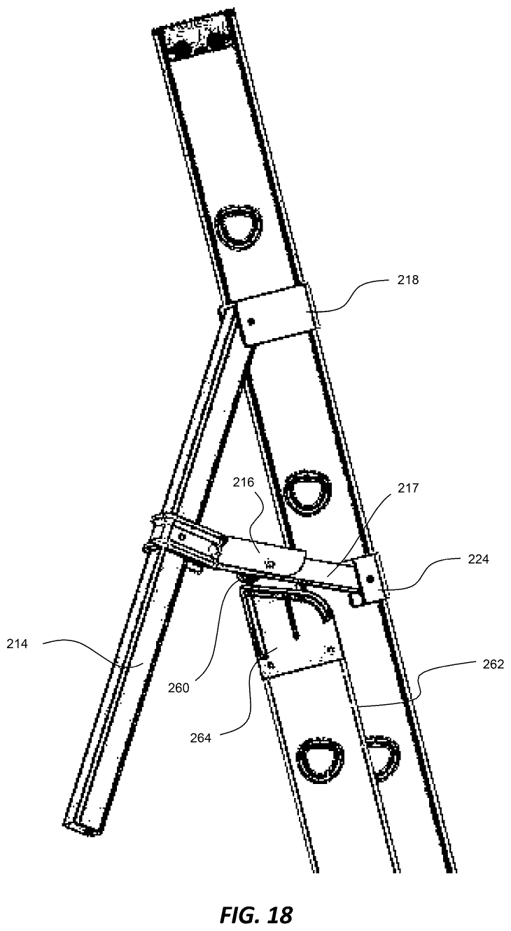

As the user adjusts the length of the ladder 200, the fly rails 201 (and the attached stabilizer mechanisms 212) may move upward. The follower 260 may be coupled to a pivot pin or similar structure to allow rolling contact against the front-facing surface 262 as the fly rails 201 move. In some embodiments, the follower 260 may slide across the front-facing surface 262. Eventually, the fly rails 201 and followers 260 may move to the top ends 264 of the base rails 209. This is shown in FIG. 17. The followers 260, which are biased rearward, may then move above the top ends 264 and may move rearward over the top ends 264, as shown in FIGS. 18-20. After the followers 260 fully clear the top ends 264, the stabilizer mechanisms 212 may freely expand and unfold, as shown in FIGS. 11-12 and 23, due to the biasing force/moment applied by the biasing member.

The fly rails 201 may shake, wobble, or otherwise displace relative to the base rails 209 as the ladder 200 is collapsed. Additionally, the upper and lower brackets 218, 224 may be configured to angle the struts 214 rearward and laterally outward in a non-orthogonal plane relative to the plane in which the fly rails 201 are positioned, similar to axes R₁ and R₂. Accordingly, the followers 260 may be laterally and rearwardly offset from the base rails 209 when the ladder 200 is being collapsed.

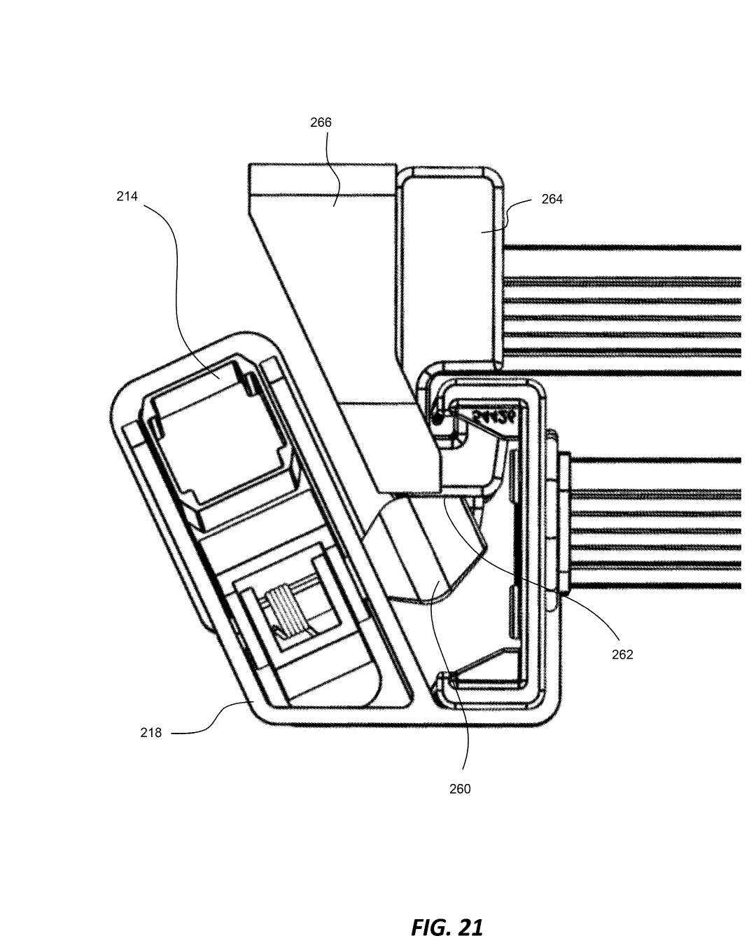

The top ends 264 of the base rails 209 may each comprise a top cap 266 (i.e., a flange portion or guide portion) configured to engage the follower 260 as the ladder 200 transitions from an extended configuration toward the collapsed configuration. The top cap 266 may have a greater lateral width than the base rail 209, as shown in FIGS. 14, 15, 19, 20, 21, and 23. The flared width of the top cap 266 may help ensure that the follower 260 re-engages the base rail 209 as the fly rail 101 collapses downward, such as when the follower 260 reaches the position of FIGS. 18-20. The top cap 266 may then guide the motion of the follower 260 laterally inward toward the front-facing surface 262 of the base rail 209 as the fly rails 201 continue to move downward, i.e., into the positions of FIGS. 17 and 21. Accordingly, the ladder 200 may automatically fold and stow the stabilizer mechanisms 212 when the fly rails 201 are collapsed. Folding the stabilizer mechanisms 212 may store potential energy in the biasing member(s), thereby enabling future expansion and unfolding action when the ladder 200 is re-extended.

In various embodiments, the ladder 200 may comprise one or two stabilizer mechanisms 212, such as one on each side of the ladder 200 or one on only one side thereof. The stabilizer mechanisms 212 may be independently deployable and stowable. Elements and features of the ladder 200 have been described in connection with FIGS. 10-23 that may be used in combination with, or in place of, features described in connection with other embodiments referenced herein. Accordingly, the embodiment shown in FIGS. 10-23 should be understood as an example embodiment having various features that may be used in isolation or as an assembly/combined sets of components and mechanisms.

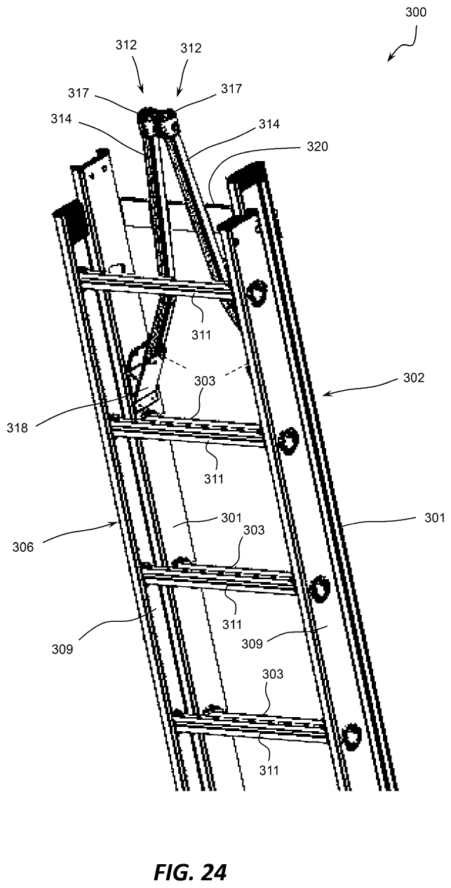

FIGS. 24-26 illustrate rear isometric views of features of a ladder 300 having a first assembly 302 and a second assembly 306 similar to the first and second assemblies of ladders 100 and 200. The first assembly 302 may include a pair of spaced apart fly rails 301 and rungs 303 that coupled to and extending between the rails 301, and the second assembly 306 may include a pair of spaced apart base rails 309 and rungs 311 that are likewise coupled to and extending between the rails 309. The ladder 300 may include a pair of stabilizer mechanisms 312 having struts 314 pivotally joined to brackets 318 positioned on laterally inner sides of the fly rails 301. The struts 314 may comprise pivot axes (e.g., as shown in broken lines in FIG. 24) that are angled relative to the longitudinal axes of the fly rails 301. The pivot axes may be angled downward relative to a horizontal plane or relative to plane in which the rungs 303, 309 are positioned.

FIG. 24 shows the upper end of the ladder 300 in a collapsed condition in which the struts 314 are positioned between a base/rear rung 311 and a front guard 320. In some embodiments, a front rung 303 may be used instead of, or in addition to, the front guard 320. The front guard 320 may have a different front-back depth and appearance than a front rung 303 in order to indicate to a user that it is not intended to be used as a step or foothold. The front guard 320 may limit forward rotation of the stabilizer mechanisms 312 so that the struts 314 do not pivot past the frontal plane in which the fly rails 301 both lie.

In the collapsed/folded position of FIG. 24, the struts 314 are also positioned to the front of the rear plane of the base rails 309, thereby ensuring that the stabilizer mechanisms 312 are entirely contained within a volumetric envelope of the first and second assemblies 302, 306. The ladder 300 therefore has a maximum width defined by the rails 301, 309 rather than (at least partially) by the stabilizer mechanisms 312, thereby improving the portability and storage/transportation size profile of the ladder 300. The stabilizer mechanisms 312 may also therefore be protected from damage by a “cage” comprising components of the first and second assemblies 302, 306.

The struts 314 may each pivot at a bracket 318 (directly coupled to or integrated into a fly rail 301) while having a free end with a foot 317 that is displaceable relative to a support surface. In some embodiments, the struts 314 may be configured to lean rearward by gravity and to therefore tilt toward the rear rungs 311. In some embodiments, the struts 314 may be biased rearward by a biasing mechanism (e.g., a torsion spring similar to spring 234 or a linear spring such as biasing member 134), such as a biasing mechanism at the bracket 318 that applies a moment to the strut 314 that drives the foot 317 rearward by rotation at the pivot axis of the strut 314 at the bracket 318. Rotation of the strut 314 may be limited or prevented due to the rung 311 being in a blocking position rearward of the strut 314.

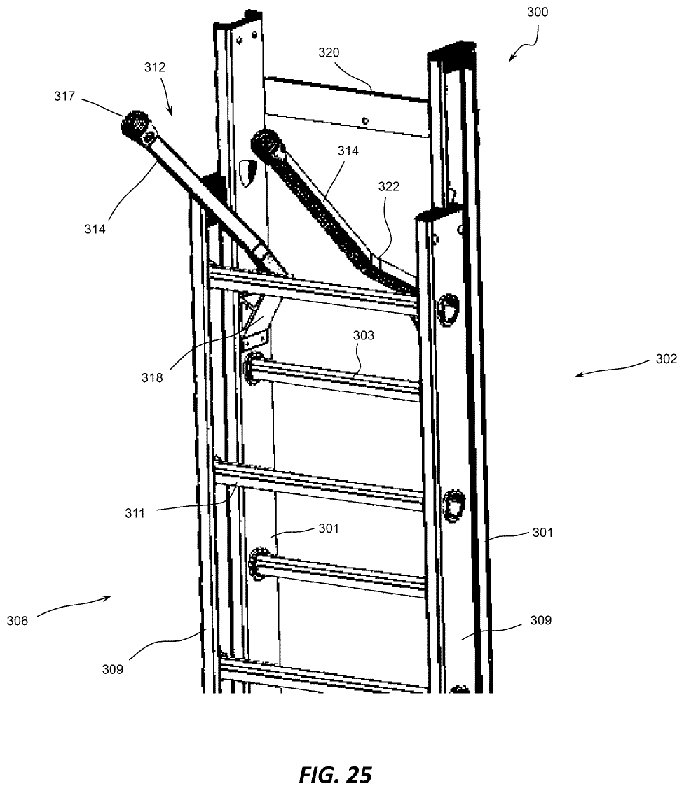

As the first assembly 302 is displaced to extend above the second assembly 306, the brackets 318 may move longitudinally upward relative to the rear rung 311, and the struts 314 may therefore begin to tilt rearward from the rear rung 311, as shown in the transitional position of FIG. 25. In this state, the weight of the strut 314, or the biasing force applied to it, may urge the strut 314 into contact with the rung 311, to be at least partially over the rung 311, and to rotate about the pivot axis at the bracket 318.

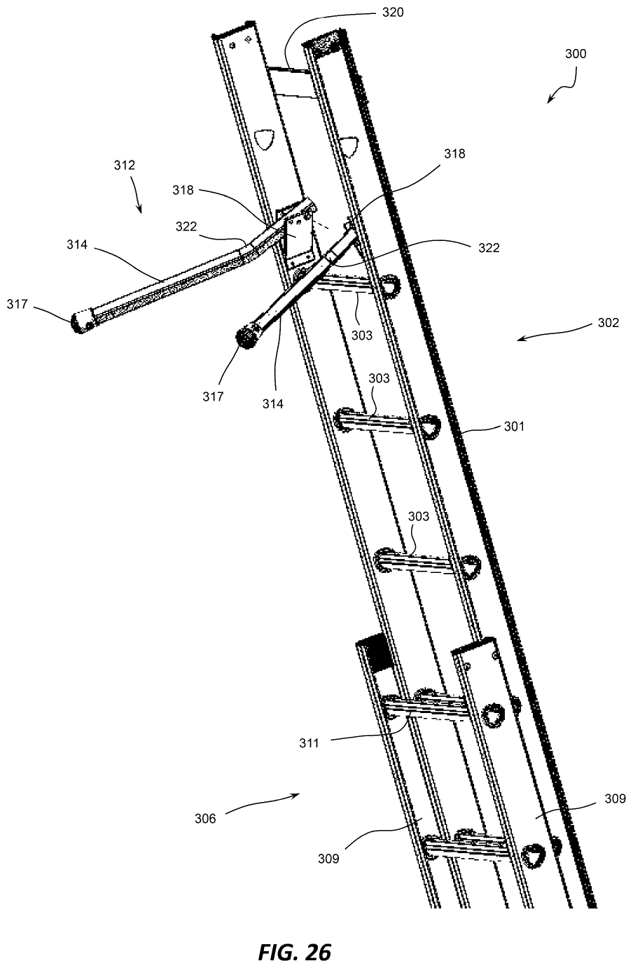

As the first assembly 302 is further displaced relative to the second assembly 306, the struts 314 may fully rotate (e.g., until a downward-facing surface of the strut 314 engages an upward-facing surface or pin of the bracket 318), as shown in FIG. 26. In the fully rotated position, the struts 314 may extend rearward and outward relative to the back sides of the fly rails 301 due to the angled orientation of the pivot axes at the brackets 318 and due to bends 322 in the struts 314 partway along their lengths. The bends 322 may ensure that a first portion (i.e., proximal portion) of each strut 314 is perpendicular to the pivot axis of the strut 314 while a second portion (i.e., distal portion) of each strut 314 is angled relative to the first portion and is more parallel to the rails 301 than the first portion while in the collapsed configuration. When fully deployed, the bends 322 may ensure that the feet 317 are positioned laterally outside the width of the fly rails 301 and behind the first assembly 302. Additionally, the bracket 318 and strut 314 may be configured so that the strut 314 deploys to a position angled partially longitudinally downward, as shown in FIG. 26, in which case a force applied to the feet 317 pushes the feet 317 downward and forward (i.e., toward a fully deployed condition) rather than upward and forward (i.e., toward a folded or stored condition). In other words, the foot 317 may rotate to a position lower than the bracket 318 from its initial position higher than the bracket 318. Thus, the stabilizer mechanisms 312 may support the upper end of the ladder 300 against a support surface without immediately collapsing toward the folded configuration.

When the ladder 300 transitions from the deployed condition toward the collapsed position, the fly rails 301 move downward until the downward-facing surfaces of the struts 314 engage a topmost rung 311 of the base assembly 306. Contact between the rung 311 and struts 314 pushes the struts 314 upward to the position of FIG. 25, overcoming any biasing force applied by a biasing member or by the weight of the struts 314. The angled pivot axes and bends 322 also cause the feet 317 to rotate laterally inward and forward. Eventually, the rung 311 moves to the position of FIG. 24, where the struts 314 are once again fully collapsed and folded within the rails 301, 309, front guard 320 (or rung 303), and rungs 311.

In various embodiments, the ladder 300 may comprise one or two stabilizer mechanisms 312, such as one on each side of the ladder 300 or one on only one side thereof. The stabilizer mechanisms 312 may be independently deployable and stowable. Elements and features of the ladder 300 have been described in connection with FIGS. 24-26 that may be used in combination with, or in place of, features described in connection with other embodiments referenced herein. Accordingly, the embodiment shown in FIGS. 24-26 should be understood as an example embodiment having various features that may be used in isolation or as an assembly/combined sets of components and mechanisms.

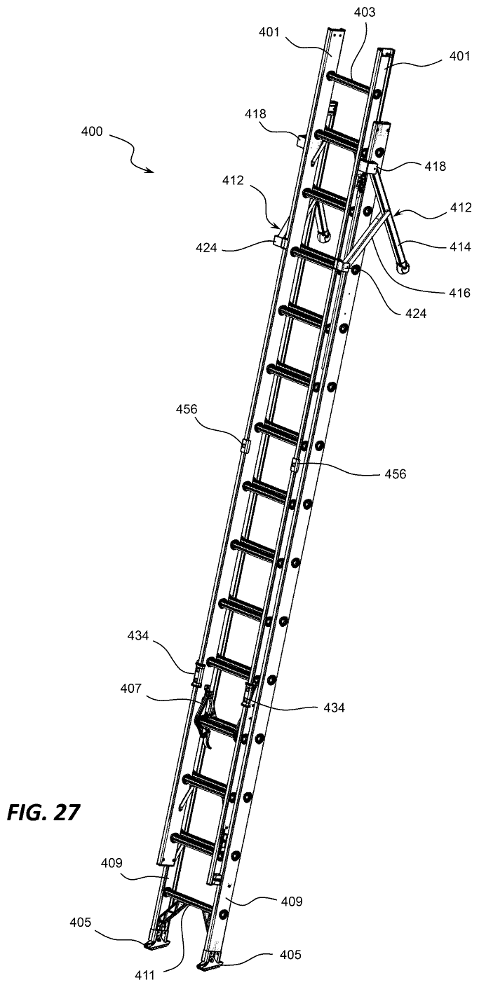

FIGS. 27-31 illustrate various views of a ladder 400 according to an embodiment of the present disclosure. The ladder 400 illustrates alternative stabilizer components that provide some functions and capabilities similar to the stabilizer mechanisms of other embodiments disclosed herein (e.g., 112, 212). The ladder 400 may include fly rails 401, base rails 409, front rungs (e.g., 403), rear rungs (e.g., 411), adjustment mechanism 407, and feet 405 that may function similarly or identically to similarly numbered components in ladder 100. In ladder 400, stabilizer mechanisms 412 may be separately and individually deployable to allow the top end of the ladder 400 to be supported by (i) one stabilizer mechanism 412 (and, e.g., another part of the ladder 400 such as a rail), (ii) both stabilizer mechanisms 412 at the same deployed angle, (iii) both stabilizer mechanisms 412 deployed at different angles, or (iv) no stabilizer mechanism 412 (e.g., supported by the rails alone or other ladder components). The stabilizer mechanisms 412 also may be manually operated by handle assemblies 434 positioned at a bottom section of the fly rails 401. Thus, in some cases, the stabilizer mechanisms 412 may not be automatically deployable or retractable. However, in some cases, the stabilizer mechanisms 412 can be spring-loaded or otherwise biased (e.g., using a spring similar to 134) in a manner similar to the embodiment of FIG. 3. The stabilizer mechanisms 412 may be stabilizer assemblies of stabilizer components.

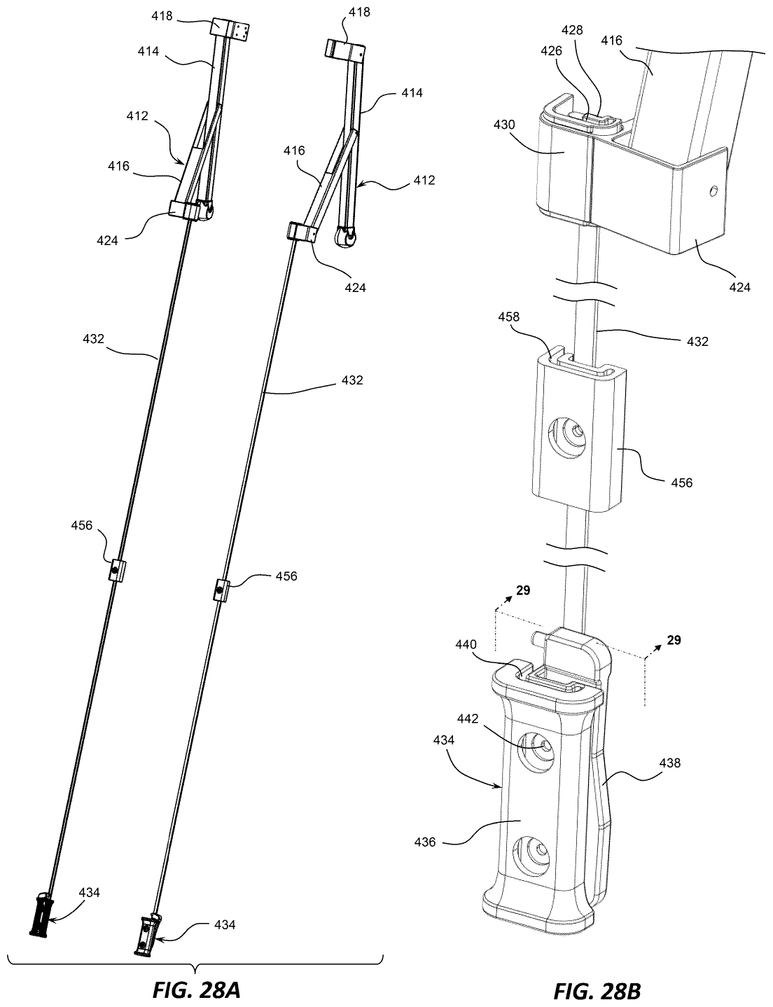

FIG. 27 shows an isometric view of the ladder 400 with the stabilizer mechanisms 412 in a partially deployed state. FIG. 28A shows the stabilizer mechanisms 412 isolated from the rest of the ladder 400, and FIG. 28B shows detail views of certain portions of the stabilizer mechanisms 412. The stabilizer mechanisms 412 may be separate, mirrored versions of each other, as shown in FIG. 28A. Thus, the stabilizer mechanism 412 on the left side of the user facing the front of the ladder 400 is deployable from the left side of the fly rails 401, and the stabilizer mechanism 412 on the opposite/right side is deployable from the right side of the rails 401. Each stabilizer mechanism 412 may include a strut 414, link member 416, first bracket 418, and second bracket 424. The strut 414 may be rotatably coupled with the first bracket 418 for movement between various deployed or stored positions. The first bracket 418 may be directly coupled with a rail (e.g., 401) and fixed in place, wherein the first bracket 418 is not moved relative to the rail when the stabilizer mechanism 412 is operated. The link member 416 may be directly pivotally coupled at its opposite ends with the strut 414 and with the second bracket 424, respectively.

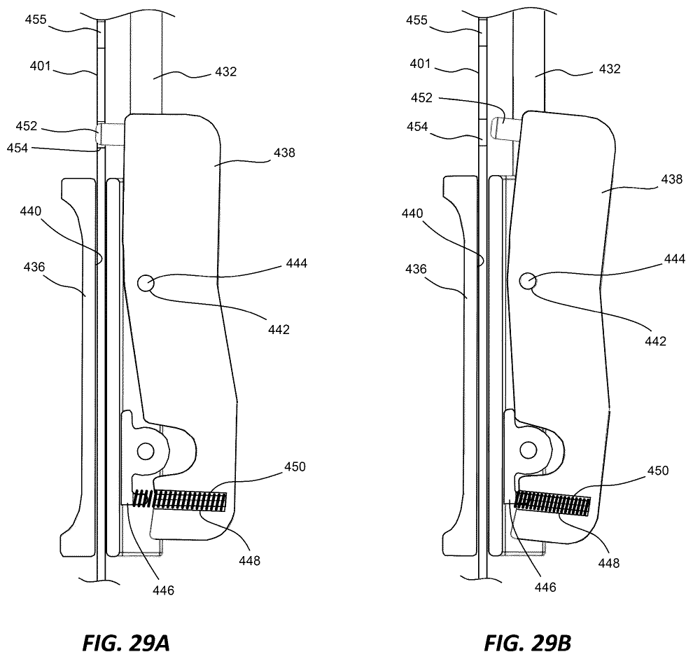

The second bracket 424 may include a channel 426 for at least partially receiving the rail (e.g., 401). See FIGS. 28B-29B. The second bracket 424 may therefore include an inner wall 428 and an outer wall 430 that each include inner faces defining the shape of the channel 426. See FIG. 28B. Thus, similar to a second bracket 124, the second bracket 424 may be longitudinally slidable along the rails. As the second bracket 424 translates longitudinally along the rails, the link member 416 may pivot about its pivot axis (at and through first bracket 418) to its various deployed or retracted positions. Furthermore, because the shape of the channel 426 at least partially receives the C- or U-shape of the flanges and/or web of the rail, the second bracket 424 may be prevented from lateral removal from the rail, such as sliding or twisting off of the rail, thereby ensuring that the stabilizer mechanism 412 does not unintentionally detach from the ladder 400. The second bracket 424 may be initially installed on the rail by sliding the terminal end of the rail into the channel 426 and then moving the second bracket 424 to its final assembly position. Alternatively, the bracket 424 may comprise multiple component parts that are assembled to form the walls 428, 430 and channel 426 around the rail.

A control rod 432 of the stabilizer mechanism 412 may have a top end coupled (e.g., directly coupled) to the second bracket 424. The control rod 432 may extend longitudinally downward along and parallel to the rail until being directly coupled to a grip body 436 of a handle assembly 434 at a bottom end of the stabilizer mechanism 412. The control rod 432 may be held within a channel formed in the laterally outer side of the rail (e.g., 401). The control rod 432 may be substantially rigid and straight, such as by comprising a metal (e.g., aluminum) or composite (e.g., fiberglass or carbon fiber composite) material formed and shaped to resist bending and buckling in a lateral direction (i.e., perpendicular to the elongated longitudinal axis of the control rod 432). For example, the control rod 432 can have a rectangular, elliptical, circular, U-beam, or I-beam-shaped cross-sectional profile. A user may apply a longitudinal force to the control rod 432 via the handle assembly 434 to longitudinally move the second bracket 424 relative to the rail and to thereby extend or retract the strut 414 via the link member 416. A separate control rod 432 and handle assembly 434 may be provided on each side of the ladder 400 to enable a user to independently adjust each of the stabilizer mechanisms 412, such as by deploying one side's strut 414 while the other strut 414 remains stationary or by deploying each strut to a different angular displacement relative to their respective rails 401.

Each handle assembly 434 may include a grip body 436 and a latch member 438. The grip body 436 may include a longitudinal channel 440 to receive the flange or web profile of the rail 401 similar to the manner of channel 426. See FIGS. 28B-29B. Thus, the grip body 436 may be longitudinally slidable long the rail 401 with the control rod 432. The top and bottom ends of the grip body 436 can be outwardly flared to assist the user's hand in applying longitudinally upward or downward pressure to the handle assembly 434 when adjusting the stabilizer mechanism 412. The grip body 436 may also include at least one opening 442 configured to receive a pivot pin 444 (see FIG. 29A-29B) or fastener pivotally coupling the latch member 438 to the grip body 436. Thus, a user may grasp the grip body 436 with part of their hand also wrapping around the latch member 438.

FIG. 29A shows a frontal section view of the handle assembly 434 as taken through section lines 29-29 in FIG. 28B. A flange portion of a rail 401 in the channel 440 is also shown for reference. The handle assembly 434 may include a bracket 446 directly coupled with the grip body 436. In some examples, the bracket 446 can attached to the grip body 436, and in some cases the bracket 446 can be integrally formed with the grip body 436 as one piece.

The latch member 438 may include a recess 448 facing the bracket 446 and configured to receive and retain a biasing member 450 (e.g., a spring) between the latch member 438 and the bracket 446. The biasing member 450 may apply a laterally-outwardly-directed force to the latch member 438 to bias the bottom end of the latch member 438 outward and to rotate about the pivot pin 444 to the position shown in FIG. 29A (e.g., away from the centerline of the ladder 400). In the position of FIG. 29A, a locking pin 452 extending laterally inward from the latch member 438 (i.e., toward the substantially vertical centerline of the ladder 400) is positioned through an aperture 454 in the rail 401, thereby preventing the handle assembly 434 from longitudinally moving (e.g., sliding) relative to the rail 401. In the configuration shown in FIG. 29A, the latch member 438 may therefore be referred to as being in a locked position relative to the grip body 436 and the rail 401. The locked position can also be referred to as a rest position, wherein a clamping force sufficient to overcome the biasing force of the biasing member 450 is not applied, and the latch member 438 is at rest.

In response to a laterally-inwardly-directed force to the latch member 438, such as a hand clamping or squeezing the latch member 438 toward the grip body 436, the biasing member 450 can be compressed, and the latch member 438 can rotate the locking pin 452 out of the aperture 454, as shown in FIG. 29B. Accordingly, the handle assembly 434 can be enabled to move or slide relative to the rail 401, and the latch member 438 in the configuration of FIG. 29B can be referred to as being an unlocked position or a compressed position relative to the grip body 436 and the rail 401. Due to this functionality, the handle assembly 434 can be referred to as being a rocking handle or rockable grip.

A rocking handle and pin 452 may provide convenience and ease of use (e.g., one-handed operation). In some configurations, which will be understood by those having skill in the art and having the benefit of the present disclosure, a latch member 438 may be omitted, and a separate, removable pin, hook, fastener, nail, clip, carabiner, or other latch may be used to secure the grip body 436 to the rail 401 by passing through aligned apertures in the rail and grip body, and the removable device can be removed from at least one of the aligned apertures to permit sliding of the grip body 436 relative to the rail 401.

The control rod 432 can also be coupled to a sliding support bracket 456 that is coupled to the rail 401. See FIGS. 28A and 28B. The sliding support bracket 456 can include a channel 458 configured to receive the profile of the web or flange of the rail 401, similar to channels 426 and 440, and to thereby slide along the rail 401 as the control rod 432 adjusts the second bracket 424. The sliding support bracket 456 can therefore help limit or prevent bending or buckling of the control rod 432 while it is being used to transfer force from the handle assembly 434 to the second bracket 424. The sliding support bracket 456 can also prevent the control rod 432 from laterally bending or bowing out of the rail channel. The sliding support bracket 456 can be directly coupled to the control rod 432 so that the position of the control rod 432 relative to the bracket 456 does not change as the rod 432 moves.

In some embodiments, multiple sliding support brackets 456 may be spaced along the length of the control rod 432 to add additional stiffness. In some embodiments, no sliding support brackets 456 may be included. In some cases, at least one support bracket similar to sliding support bracket 456 may be affixed to and remain stationary relative to the rail 401, and the control rod 432 may longitudinally slide relative to the bracket while being laterally retained by the bracket.

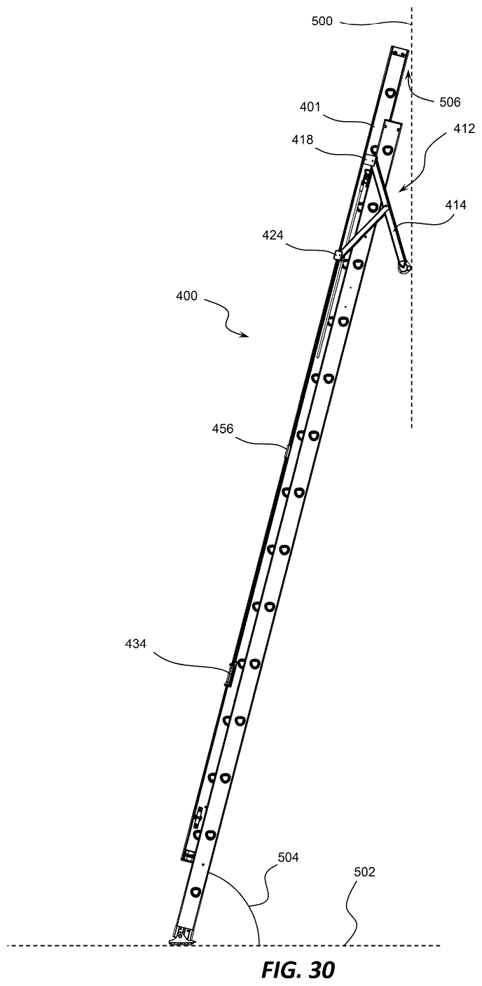

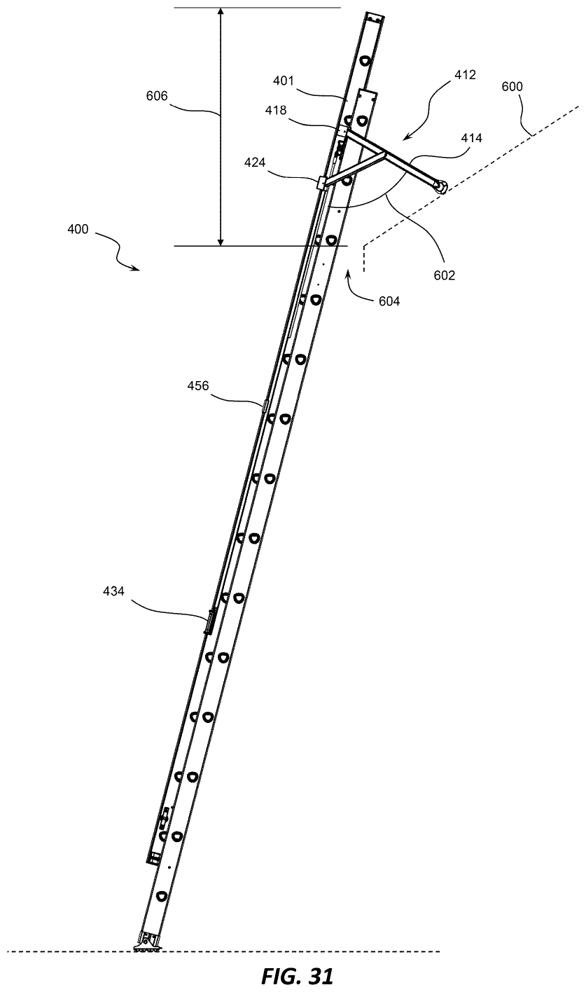

Additional apertures (e.g., 455, similar to 454) can be positioned at various spaced apart longitudinal positions along the length of the rail 401 so that the locking pin 452 can lock the stabilizer mechanism 412 in various different positions relative to the rail 401. For example, a first locked position of the handle assembly 434 can correspond to a collapsed position of the strut 414 (e.g., similar to the position of FIG. 1), a second locked position can correspond to a wall standoff position of the strut 414 (e.g., as shown in FIGS. 27 and 30), a third locked position can correspond to a roof standoff position of the strut 414 (e.g., as shown in FIG. 31), and additional locked positions can correspond to other strut states. Thus, a plurality of locked positions of each stabilizer mechanism 412 can allow a variety of different support conditions for the ladder 400, wherein the struts 414 can provide support at various angles from the rails 401 (or can provide no support, such as when the ladder 400 is supported by one or more rails 401 instead).

FIG. 30 illustrates a side view of the ladder 400 of FIG. 27. The ladder 400 may include a locked position of the strut 414 enabling the ladder 400 to be supported (e.g., leaned) against a vertical surface 500 by only the struts 414 at the top portion of the ladder 400 while the feet 405 are positioned on a horizontal ground support surface 502 and while the rails (e.g., 401, 409) form an angle (e.g., 504) relative to the ground surface of about 75 degrees. In some embodiments, the angle 504 can be within a range of about 65 degrees to about 85 degrees, such as when the ground surface is gently sloped upward or downward (e.g., by up to plus or minus about 10 degrees). Thus, the ladder 400 can be supported against the vertical surface 500 without the rails 401 contacting the vertical surface 500 due to the size and positioning of the struts 414 relative to the size and positioning of the rails 401. An air gap 506 may be formed between the vertical surface 500 and the top terminal ends of the rails 401. This wall-support configuration can enable the ladder 400 to be used in positions where contacting the vertical surface between the struts 414 may be undesirable, such as when the rails 401 would contact a window, paint, or other fragile or sensitive surface, but the struts 414 would not contact that surface.

FIG. 31 is similar to the side view of FIG. 30 but shows the stabilizer mechanisms 412 in a different deployed state. Compared to the partially deployed/wall-supported state of FIG. 30, the handle assemblies 434 are translated longitudinally upward along the rails 401, and the struts 414 are therefore also extended to form a larger angle 602 between the struts 414 and the rails 401 while the rails 401 form the same angle (e.g., 504) (or fit within the same range of angles) with the ground as described above in connection with FIG. 30. In some embodiments, the struts 414 can move to a maximum angle 602 relative to the rails of about 90 degrees. In some embodiments, the struts 414 can extend to a maximum angle 602 of about 80 to about 85 degrees away from the rails. A range limited to a position less than 90 degrees can help ensure that the struts 414 do not bind when fully extended and therefore remain retractable back to their collapsed positions when needed.

When fully extended or at relatively high displacement angles 602, the struts 414 can enable the ladder 400 to be supported by a sloped upward-facing surface 600 on an elevated structure, such as a rooftop or awning, without the rails 401, 409 contacting the elevated structure, as shown in FIG. 31. This configuration can limit or prevent the ladder 400 from pressing against fragile edges or side structures on the elevated structure, such as contacting gutters, paint, or lights at the edge of a rooftop. Thus, a gap 604 can be formed between the edge of the rooftop and the nearest rails of the ladder 400. In some embodiments, the size and positioning of the struts 414 can allow support against various roof pitches, such as a 2/12 pitched top surface (e.g., 2 inch rise per 12 inch run or about 9.4 degrees from horizontal) or a 6/12 pitched surface (e.g., 6 inch rise per 12 inch run or about 26.5 degrees from horizontal). The positioning of the stabilizer mechanisms 412 can be adjusted as appropriate for various roof pitch conditions so that the base angle (e.g., 504) of the ladder 400 remains within a preferred range.

The struts 414 can also be coupled to the ladder 400 at the first brackets 418 at a position displaced downward from the terminal upper ends of the rails 401. For instance, the first brackets 418 can be positioned about two feet below the terminal upper ends so that at least two feet of the rails 401 extend upward above any surface against which the struts 414 support the ladder when the struts 414 are fully extended. In some embodiments, the ladder 400 can be configured to have at least three feet of rail length extending above the edge of a nearby rooftop or other elevated sloped structure when the struts 414 are maximally extended and in contact with the top sloped surface thereof. In some embodiments, the ladder 400 may include at least three (and in some cases four or more) rungs positioned at the same level or higher than a contact point between a fully extended strut 414 and a sloped surface (e.g., 600) when the rails 401 are within a preferred range of angles (e.g., 504) relative to the ground. The roofline-to-top of ladder dimension (e.g., 606) can reach or exceed about three feet in order to ease movement of the user from climbing the ladder 400 to standing on the rooftop 600 by ensuring that the top ends of the fly rails 401 are extending high enough above the rooftop 600 for the user to use them as a grip or handle while exiting or stepping on the ladder to or from the rooftop 600.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including:” and “having” come as used in the specification and claims shall have the same meaning as the term “comprising.”

What is claimed is:

1. A ladder, comprising:
a first assembly including a first pair of rails and a first plurality of rungs extending between and coupled to the first pair of rails;
a second assembly including a second pair of rails and a second plurality of rungs extending between and coupled to the second pair of rails, the second pair of rails being displaceable relative to the first pair of rails between a collapsed configuration and an extended configuration; and
a stabilizer mechanism mounted to at least one rail of the first pair of rails and including:
a strut having a top end and a bottom end, the top end being pivotally coupled with the at least one rail on a laterally outer side of the at least one rail; and
a biasing member, wherein in response to displacement of the first pair of rails from the collapsed configuration to the extended configuration, the biasing member applies a force to the stabilizer mechanism pivoting the strut at the top end to extend the bottom end outward relative to the at least one rail.

2. The ladder of claim 1, wherein the stabilizer mechanism further comprises:
a link member pivotally coupled to the strut; and
a pivot bracket slidably coupled with the at least one rail of the first pair of rails and pivotally coupled to the link member.

3. The ladder of claim 2, wherein the biasing member is configured to apply the force to the pivot bracket to pivot the strut via the link member.

4. The ladder of claim 2, wherein the stabilizer mechanism further comprises:
a second strut pivotally coupled with a second rail of the first pair of rails;
a second link member pivotally coupled to the second strut; and
a second bracket slidably coupled with the second rail and pivotally coupled to the second link member.

5. The ladder of claim 4, wherein the stabilizer mechanism further comprises a cross-link member coupling the pivot bracket and the second bracket.

6. The ladder of claim 1, wherein, when the strut is in the collapsed configuration, the strut is substantially parallel to the at least one rail.

7. The ladder of claim 1, wherein a pivot axis of the strut is oriented at a non-orthogonal angle relative to a plane in which the first pair of rails lies.

8. The ladder of claim 1, wherein the strut is configured to rotate laterally outward relative to the at least one rail.

9. The ladder of claim 1, wherein the biasing member is directly coupled with the at least one rail.

10. The ladder of claim 1, further comprising a ramp formed on the at least one rail, wherein the strut is configured to pivot into contact with the ramp.

11. The ladder of claim 10, wherein the ramp comprises a surface configured to resist movement of the strut away from the collapsed configuration.

12. A ladder, comprising:
a first assembly including a first pair of rails and a first plurality of rungs extending between and coupled to the first pair of rails;
a second assembly including a second pair of rails and a second plurality of rungs extending between and coupled to the second pair of rails, the second pair of rails being displaceable relative to the first pair of rails between a collapsed configuration and an extended configuration; and
a stabilizer mechanism mounted to at least one rail of the first pair of rails and including:
a strut having a first end and a second end, the first end being pivotally coupled with at least one rail of the first pair of rails;
a link member pivotally coupled with the strut;
a bracket slidably coupled with the at least one rail;
a handle assembly slidably coupled with the at least one rail and coupled with the bracket, wherein sliding movement of the handle assembly is configured to pivot the strut via the bracket and via the link member.

13. The ladder of claim 12, wherein the handle assembly comprises a grip body and a latch member coupled with the grip body, the latch member being movable between a first position locking the grip body relative to the at least one rail and a second position permitting movement of the grip body relative to the at least one rail.

14. The ladder of claim 13, wherein the latch member is lockable relative to the at least one rail in a plurality of spaced apart positions on the at least one rail.

15. The ladder of claim 12, wherein the stabilizer mechanism further comprises a rod linking the handle assembly to the bracket.

16. The ladder of claim 15, wherein the stabilizer mechanism further comprises a support bracket coupled to the at least one rail and to the rod.

17. The ladder of claim 12, wherein the strut is a first strut and the ladder further comprises a second stabilizer mechanism including:
a second strut pivotally coupled with a second rail of the first pair of rails;
a second link member pivotally coupled with the second strut; and
a second bracket slidably coupled with the second rail;
wherein the second strut is deployable to a first angular displacement from the second rail while the first strut is deployed to a second angular displacement from the at least one rail.

18. A stabilizer mechanism for a ladder, the stabilizer mechanism comprising:
a strut having an end pivotally attachable to a rail;
a bracket slidably attachable to the rail;
a link member having a first end pivotally attached to the strut and a second end pivotally attached to the bracket, wherein movement of the bracket relative to the end of the strut is configured to rotate the strut via the link member; and
a handle assembly slidably attachable to the rail and coupled with the bracket.

19. The stabilizer mechanism of claim 18, wherein the bracket forms a channel configured to receive a web or flange portion of the rail.

20. The stabilizer mechanism of claim 18, wherein the handle assembly comprises a latch member configured to lock the handle assembly relative to the rail.
